(19) United States
(12) Patent Application Publication
(10) Pub. No.: US 2016/0132816 A1
(43) Pub. Date: May 12, 2016

(54) Unified Workforce Platform

(71) Applicant: QMerit, Inc., Irvine, CA (US)

(72) Inventor: Greg Lush, Dove Canyon, CA (US)

(21) Appl. No.: 14/869,983

(22) Filed: Sep. 29, 2015

Related U.S. Application Data
(60) Provisional application No. 62/078,302, filed on Nov. 11, 2014.

(51) Int. Cl. G06Q 10/06; H04L 29/08

(52) U.S. Cl. CPC G06Q 10/063112; H04L 67/02; H04L 67/10

(57) ABSTRACT

A non-transitory computer readable storage medium having stored thereon instructions, the instructions being executable by one or more processors to perform operations including: receive information describing an issue requiring assistance by one or more service providers; generate a work activity based on the received information, the work activity including a standard format populated with at least a portion of the received information; generate a notification schedule, the notification schedule being an ordering of a subset of qualified service providers of the one or more service providers in which the subset of qualified service providers are to be notified of the work activity; and notify one or more service providers of the subset of qualified service providers of the work activity, the one or more service providers of the subset of qualified service providers selected according to the notification schedule is shown.

### PRIORITY

This application claims the priority benefit to U.S. Provisional Application No. 62/078,302, filed Nov. 11, 2014, which is incorporated by reference in its entirety into this application.

### BACKGROUND

When an organization needs a service, it is desired to get the right person to the right place at the right time to perform the service for the organization. However, managing service providers and personnel to ensure that organizations are served in an ideal manner can be very challenging. Many variables are involved, including whether the service provider has the requisite skill to provide the required service or address the organization's problem, whether the service provider is located sufficiently close to the location requiring the service, etc. Further, when services required become mixed between technical and non-technical businesses, white collar businesses and blue collar businesses, etc., the number of variables compound and it becomes more difficult to ensure the right person is selected and can make it to the right place at the right time.

An additional concern is to ensure that the service provider has the information and materials to successfully complete a work activity. A system and/or platform that can provide vast stores of relevant knowledge in an easy to use and mobile format that may be accessed at the work site would be highly beneficial. “Cloud computing” is an example of internet-based dynamically scalable computing that can facilitate access to information from a variety of devices in a variety of locations. Also, dynamically scalable computer systems allow users to increase or decrease the computer processing power used as needed based on the current processing needs of a system or platform. Users of cloud computing generally do not need knowledge, expertise, or control of details related to the infrastructure in cloud computing because the technology infrastructure is located in “the cloud.” Cloud computing infrastructure may be provided as a service over the internet and may be dynamically scalable.

Cloud computing may allow users to avoid capital expenditures related to, for example, hardware and software because much of the processing, memory, and software are provided by one or more other companies over the internet. Accordingly providing services using cloud computing may allow a user to use a less expensive computing device (e.g., with less memory and/or processing power) to access the services. Systems and services using cloud computing may have low barriers to entry, shared infrastructure and costs, low management overhead, and immediate access to a broad range of applications.

Systems of engagement will fuel business growth and innovation over the next decade. The journey will require some jolting decisions and a sophisticated approach to solution development. It will become more and more important for service providers and service companies to: (1) improve satisfaction, improve customer loyalty, provide incentive for customers to continue using the service provider, and improve trust; (2) drive value for customers and instill in them a self-service habit; (3) increase business productivity and drive cost out of internal processes; and (4) create significant new revenue sources from smart products and services.

Many companies currently use only technology, programs, and/or knowledge created or developed by the company itself, even when perfectly good or even superior options are available outside the company. This requires allocating time and resources to re-inventing and re-creating technology, programs, and/or knowledge that are already available. This wastes time and resources that could be used in more productive ways. Accordingly, it would be beneficial to have system that integrates and makes available technology, programs, knowledge, and/or core competencies of trusted partners in a standard format (e.g., in a shareable content object reference model) such that the technology, programs, knowledge, and/or core competencies may be more easily shared, and will not require each company to essentially “reinvent the wheel.”

Disclosed herein are new systems, platforms, and methods for workforce, service, information, activity, dispatch, and/or learning management, which avoid disadvantages currently experienced and help satisfy the goals, such as those described above. The concepts described herein may be applied to a wide variety of industries and organizations.

### SUMMARY

Described herein are new methods, systems, and platforms for workforce, service, information, activity, dispatch, and/or learning management. In one embodiment, the method and system involve a unified workforce platform that allows for sophisticated work distribution, behavioral modification, and dynamic learning/training. The methods, systems, and platforms described herein may be used, for example, to: (1) improve satisfaction, improve customer loyalty, provide incentive for customers to continue using the service provider, and improve trust; (2) drive value for customers and instill in them a self-service habit; (3) increase business productivity and drive cost out of internal processes; and (4) create significant new revenue sources from smart products and services. A unified workforce platform as described herein may encompass methods, systems, and platforms for workforce, service, information, behavior, activity, dispatch, and/or learning management. The platform may be used to help unify personnel of one or more companies and provide tools to share information, learning, labor, services, improve behavior, and/or other things. In one embodiment, the method and system involve a unified workforce platform that allows for sophisticated work distribution, behavioral modification, and dynamic learning/training.

In one embodiment, a unified workforce platform acts as a middleware product that provides its users with contextual insight and promotes collective intelligence. A variety of users in a variety of roles may consume and/or contribute to the unified workforce platform, e.g., field personnel (e.g., service provider), office (e.g., administrators and/or officers), and clients (e.g., companies in need of services). The unified workforce platform may use a pure cloud computing based platform as a service model. The unified workforce platform may be used to match service, industry, skill and work activity type before processing through numerous logistical and business variables to locate the right person for the work activity, and may also use a socially governed user environment to help match work activity with labor resources. The unified workforce platform may provide what the user needs before the user knows he/she needs it (e.g., predicting what information the user might be interested in and having it easily available for the user, for example, with tiles and/or media tailored to industry and service area). The unified workforce platform may also optimize the use of a foundational service bus and metadata management components (e.g., massaging and managing information (metadata, tags, information about information) to make better decision). The unified workforce platform is a holistic framework which optimizes contextual service information to its participants thus sharply increasing productivity and amplifying field level esprit de corps.

The unified workforce platform may be considered a contextual activity platform or management system used to manage all types of service activities, work, learning, safety, etc. A part of unified workforce platform may deliver assessment tests to users based off of their declared industry-service-skill to confirm knowledge and facilitate automated dispatch algorithms. A learning engine of the unified workforce platform may provide the ability to force the user through a preliminary activity and post activity when sent the primary assessment. The workflow and logic around when the user gets what learning content, which is delivered and managed by the learning engine, makes up some of the functionality of the learning engine.

In one embodiment, a management system (e.g., a unified workforce platform) may comprise a dynamically scalable computing resource including a processor and a memory coupled to the processor, wherein the memory stores instructions capable of causing the processor to do one or more of the following: gather information regarding a work order from a client's system; create and store a work activity based on the work order, wherein the work activity is populated with qualification requirements necessary for a user to qualify to be paired with the work activity; compare information about users to the qualification requirements of the work activity to identify a group of qualified candidates that satisfy the qualification requirements; establish a notification schedule to determine when each individual of the group of qualified candidates will be notified about the work activity; and deliver notifications two or more individuals of the group of qualified candidates about the work activity at different times according to the notification schedule. The dynamically scalable computing resource may be a virtual resource available over the internet. The management system may include one or more of the other features of the systems, platforms, etc. (e.g., the unified workforce platform) described elsewhere herein, and may cause a processor to perform the functions described elsewhere herein.

Further, establishing a notification schedule may include analyze points earned by each individual of the group of qualified candidates and establish the notification schedule such that individuals of the group of qualified candidates with more points are scheduled to be notified about the work activity prior to individuals of the group of qualified candidates with fewer points. Optionally, establishing a notification schedule may include determine a point total of all points of the group of qualified candidates, determine a percentage of individual points of each individual of the group of qualified candidates compared to the point total, and establishing the notification schedule such that individuals of the group of qualified candidates with a higher percentage are scheduled to be notified about the work activity prior to individuals of the group of qualified candidates with a lower percentage. Determining a percentage of individual points of each individual of the group of qualified candidates compared to the point total may also include applying client preference criteria to the individual points of each individual of the group of qualified candidates to increase or decrease the individual points prior to determining the percentage.

In one embodiment, a method of pairing work projects with workers, may comprise causing a computing resource including a processor and a memory to do one or more of the following: obtain information about a pending work project from a client's system; create a work activity based on the information about the pending work project using a processor and store the work activity in the memory, wherein the work activity is populated with qualification requirements necessary for a worker to qualify to be paired with the work activity; compare information about workers to the qualification requirements of the work activity to identify a group of qualified candidates that satisfy the qualification requirements; establish a notification schedule to determine when each individual of the group of qualified candidates will be notified about the work activity; and deliver notifications two or more individuals of the group of qualified candidates about the work activity at different times according to the notification schedule. When each individual of the two or more individuals receives a notification, the individual may be provided with the option of accepting the work activity using the computing resource. Further, establishing a notification schedule may include causing the computing resource to analyze client preference criteria and establish the notification schedule in a way that reflects the client preference criteria. The client preference criteria may include a client's preference that employees of the client be notified about the work activity before independent contractors are notified. Optionally, establishing a notification schedule may include analyzing points earned by each individual of the group of qualified candidates and establishing the notification schedule such that individuals of the group of qualified candidates with more points are scheduled to be notified about the work activity prior to individuals of the group of qualified candidates with fewer points. The method may include other steps described elsewhere herein.

In one embodiment, a method of repairing equipment may comprise accepting, via a management system run on a dynamically scalable computing resource including a processor and a memory coupled to the processor, a work project to repair the equipment, the work project providing a link on the management system to media associated with the equipment. The method may also include accessing the media through the link on the management system using a mobile computing device at a location of the equipment and/or viewing the media associated with the equipment through the management system using the mobile computing device. The method may also include repairing the equipment using information in the media. The method may include other steps described elsewhere herein.

In one embodiment, a method of repairing equipment may comprise accepting, using a management system run on dynamically scalable computing resource including a processor and a memory coupled to the processor, a work project to repair the equipment, the management system including information associated with the work project about service providers who have repaired the equipment in the past. The method may also include sending a message through the management system to one or more of the service providers who have repaired the equipment in the past requesting information about the equipment. The method may also include receiving a message including the information through the management system from the one or more service providers who have repaired the equipment in the past, and/or repairing the equipment using the information. The method may include other steps described elsewhere herein.

### BRIEF DESCRIPTION OF THE DRAWINGS

The systems and methods described herein may be understood by reference to the following description taken in conjunction with the following drawings, in which like reference numerals identify like elements, and in which:

FIG. 1 shows an exemplary screen/monitor view of an interface to an exemplary unified workforce platform.

FIG. 2 shows a close up view of a portion of an exemplary screen/monitor view of an interface to an exemplary unified workforce platform, similar to the upper right hand corner portion of FIG. 1.

FIG. 3 illustrates a “pull” method of work distribution that may be used with a unified workforce platform.

FIG. 4 shows an exemplary declaration of skills webpage of an exemplary unified workforce platform.

FIG. 5 illustrates one example of how criteria or requirements associated with a work activity may be used to match the right person with the work activity.

FIG. 6 shows a graph indicating how a user's point total may influence when a user is notified of new work activities.

FIG. 7 shows a formal learning page and a dynamic and contextual learning page of an exemplary unified workforce platform.

FIG. 8 shows an interface of an exemplary unified workforce platform as viewed from a mobile device, and a reveal button or expansion arrow has been pressed to reveal additional tools.

FIG. 9 shows a diagram of features of an exemplary unified workforce platform that may be used in location tracking.

FIG. 10 shows a “[client] work activity” page of an exemplary unified workforce platform with 8 tiles on the page that may be accessed by a client of the unified workforce platform.

FIG. 11 shows a “[learn]ing” page of an exemplary unified workforce platform with 9 tiles on the page.

FIG. 12 illustrates how the unified workforce platform may operate as an integration platform.

FIG. 13 shows a table of behaviors and other measurements that a points engine m of a unified workforce platform may use for calculating point totals for users of the system.

FIG. 14 shows a page of an exemplary administrative portal of an exemplary unified workforce platform on which an administrator may massage or change the amount of points awarded or deducted for various activities.

FIG. 15 shows a page of an exemplary administrative portal of an exemplary unified workforce platform on which an administrator may change a wide variety of variables to customize or tailor the unified workforce platform to the particular needs of the organization or group of organizations to which the administrator belongs.

FIG. 16 shows an exemplary “my role” section of an exemplary interface of an exemplary unified workforce platform.

FIG. 17 shows an exemplary drop down menu of an exemplary jump bar of an exemplary unified workforce platform.

FIG. 18 shows an exemplary screen view after an exemplary “launch media” tile has been clicked or selected, and shows a list of new media that the user has not yet reviewed.

FIG. 19 shows an exemplary page of an exemplary dynamic/contextual learning module in which a reveal button or expansion arrow has been clicked to reveal additional tools or “charms” to navigate and interact with the dynamic/contextual learning module.

FIG. 20 shows a diagram of factors that influence an exemplary hopper of an exemplary unified workforce platform and help the hopper to work properly for efficient and effective work distribution.

FIG. 21 shows a page of an exemplary administrative portal of an exemplary unified workforce platform on which an administrator may massage or change the amount of points awarded or deducted for various activities.

FIG. 22 shows an exemplary model for how team members may be selected for a project using the unified workforce platform.

FIG. 23 shows an exemplary side-by-side model for how individuals may be paired with work activities and how team members may be paired to a team project or project slip.

FIG. 24 shows a diagram of exemplary components and/or aspects of an exemplary unified workforce platform titled, in one embodiment, the unified workforce galaxy.

FIG. 25 shows a diagram of aspects of an exemplary learning component of an exemplary unified workforce platform.

FIG. 26 shows a diagram of aspects of an exemplary learning component of an exemplary unified workforce platform.

FIG. 27 shows an exemplary model of how a work activity may be handled in an exemplary unified workforce platform.

FIG. 28 shows a diagram of ways local labor may interact with an exemplary unified workforce platform and features of the exemplary unified workforce platform that impact the local labor.

FIG. 29 shows a diagram of aspects and/or components of an exemplary hopper of an exemplary unified workforce platform.

FIG. 30 shows a diagram of aspects of exemplary scoring or points engine logic of an exemplary unified workforce platform.

FIG. 31 shows a diagram of aspects of an exemplary social component of an exemplary unified workforce platform.

FIG. 32 shows a diagram of aspects and/or components of an exemplary an exemplary unified workforce platform.

FIG. 33 shows a diagram of ways manufacturers may interact with an exemplary unified workforce platform and features of the exemplary unified workforce platform that impact the manufacturers.

FIG. 34 shows a diagram of aspects of an exemplary social component of an exemplary unified workforce platform.

FIG. 35 shows an exemplary model for purchase order management.

FIG. 36 shows a diagram of factors and/or components of an exemplary unified workforce platform related to purchase order management.

FIG. 37 is a second diagram of factors that influence exemplary hopper logic of an exemplary unified workforce platform.

FIG. 38 is an exemplary work activity that qualifies as a dynamic activity task.

FIG. 39 is a flowchart illustrating an exemplary method for generating and completing a sequence of events for a work activity.

FIG. 40 is a flowchart illustrating an exemplary method for generating a work activity that qualifies as a dynamic activity task.

FIG. 41 is an illustration of a first exemplary work activity and a second exemplary work activity.

FIG. 42 is an exemplary illustration of a flow of a process of generating a condition-generated work activity.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Described herein are new methods, systems, and platforms for workforce, service, information, activity (e.g., work activity or work order), dispatch, and/or learning management, etc., including features/steps believed to provide advantages over existing methods, systems, and platforms for workforce, service, information, and/or learning management. The description and accompanying figures, which describe and show certain embodiments, are made to demonstrate, in a non-limiting manner, several possible platforms, systems, methods, etc. according to various aspects and features of the present disclosure. Accordingly, the disclosure is not limited to the specific embodiments described. Rather, the inventive principles associated with the embodiments described herein, including with respect to the platforms, systems, components, methods, etc. described herein, may be applied in a variety of ways, including to other types of platforms, systems, components, methods, etc. For example, while the description describes, by way of example, a unified workforce platform, it is intended that this patent cover other platforms, systems, methods, etc., including other management platforms and/or individual pieces or components of the unified workforce platform.

General methods, systems, and platforms are described herein sufficient to enable one to develop a variety of implementations/applications without undue experimentation. In the development of particular applications, numerous implementation-specific decisions will be made to achieve the design-specific goals, which will vary from one implementation/application to another. It will be appreciated that such a development effort would be a routine undertaking for persons of ordinary skill in the art having the benefit of this disclosure.

A platform (e.g., a unified workforce platform) may be provided to help manage a workforce, services, information, learning, and/or help achieve personnel objectives as discussed in more detail below. The platform (e.g., a unified workforce platform) may comprise hardware and software components. The platform (e.g., a unified workforce platform) may include memory, one or more processors, one or more computers, one or more server/servers, one or more networks, one or more monitors, one or more keyboards, one or more interfaces, and/or other components known for use in computer systems. The platforms, systems, and methods described herein may use a dynamically scalable computing resource (e.g., cloud computing) configured to increase or decrease computing capacity and/or to allow access to the system from a variety of devices in a variety of locations. The dynamically scalable computing resources may include memory, one or more processors, one or more computers, one or more server/servers, one or more networks, and/or other computing resources. Memory used in the platform(s) may be coupled to or be accessible by one or more processors for storing and/or providing access to instructions and data. The memory may store instructions causing the processor to perform any of the steps or features of the platforms, systems, and/or methods described herein.

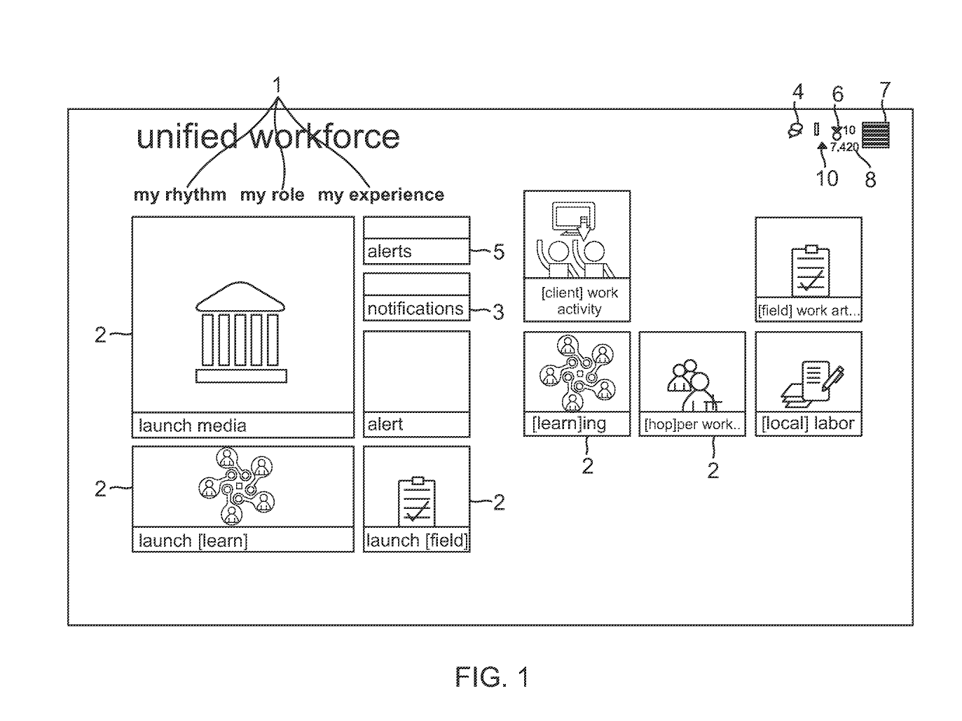

FIG. 1 illustrates an exemplary screen/monitor view of an interface to an exemplary unified workforce platform, referred to in one embodiment as “unified workforce.” The unified workforce platform may be programmed to run on and/or be accessed using any operating system, platform, computer, laptop, desktop, tablet, smart phone, phablet, mobile computing device, and/or similar device. The unified workforce platform may use a dynamically scalable computing resource (e.g., cloud computing technology; Microsoft Azure). The unified workforce platform may be accessed via the internet and/or via applications running on one or more of a variety of computing devices using one or more of a variety of internet browsers. The unified workforce platform may be configured to interface with a plurality of Internet browsers including a plurality of versions of each Internet browser, the unified workforce platform will be compatible across a wide variety of platforms and operating systems. For example, the unified workforce platform may be programmed or configured using HTML 5 to help ensure compatibility with a wide variety of browsers, operating systems, and platforms. For example, the unified workforce platform may work on PC, Macintosh, iPhone, Android (all iterations and versions), Windows (including 7.x and 8.x and other versions), iOS, MacOS, Ubuntu, Windows Phone, etc. If the browser is not fully compatible, it may generally be made compatible by simply downloading a more up-to-date version of the browser. However, to the extent any compatibility issues remain, a simplified outline version of the unified workforce platform may be displayed that is more likely to be compatible with older browsers and systems.

Ultimately, a significant attribute of unified workforce platforms described herein is the ability to use the right technology at the right time. For instance, if a company is using an eProcurement system named PO-A. PO-A may be plugged into a service bus of the unified workforce platform and information may be exchanged between other applications through the platform. If, in the future, the company moves to or adds a new eProcurement system named PO-B, the PO-B may readily be plugged into the service bus without issue. The unified workforce platform may be designed for compatibility and to adapt and embrace changes in systems interfacing with the unified workforce platform.

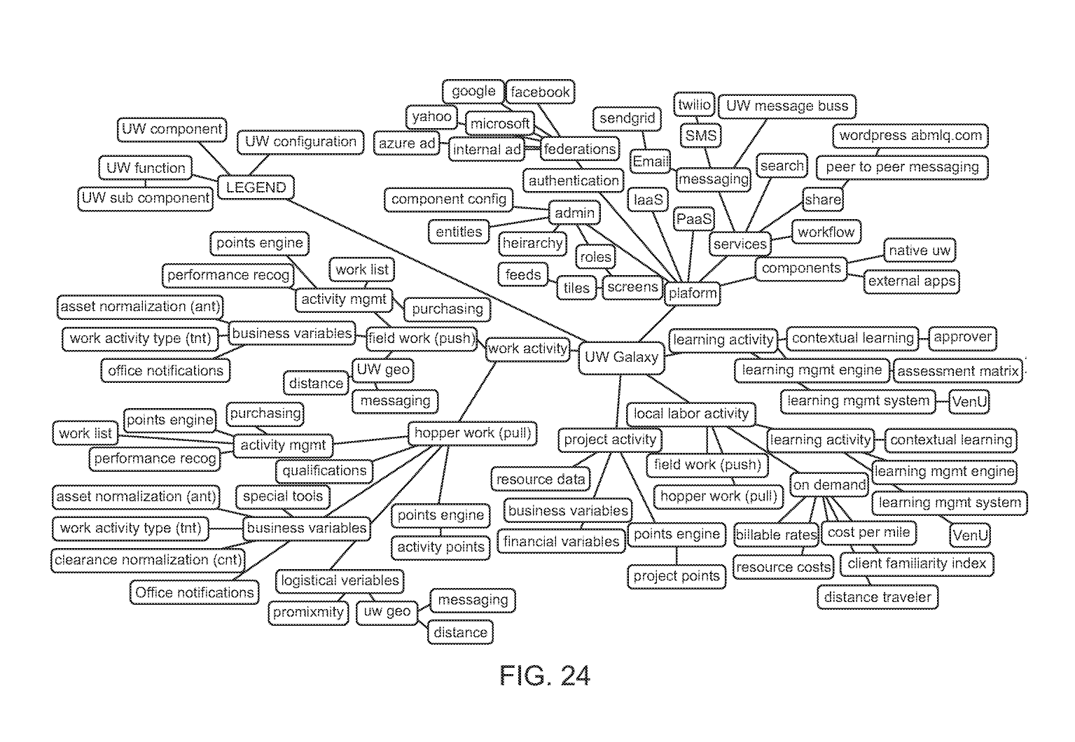

Prior to arriving at the screen shown in FIG. 1, the unified workforce platform may require authentication of the user. Authentication can be done in a variety of ways. In one embodiment, the unified workforce platform facilitates the user authentication process but does not itself authenticate users, e.g., the unified workforce platform may cooperate with other platforms in which the user already has an account for authentication. In one embodiment, authentication may be done through federations. In one embodiment, the unified workforce platform may use the user authentication through Facebook, Google, Yahoo, Microsoft, Azure Active Directory, internal active directory, Hotmail, Live, Outlook, and/or other sites to authenticate the user (see e.g., authentication branch of FIG. 24). In other words, the authentication may be configured to piggyback on or use the authentication systems of other platforms, and thereby avoid having to create a new authentication system. A user may then log in to the unified workforce platform using the user's preexisting username and password already used on Facebook, Google, Yahoo, Microsoft, etc. Although, the unified workforce platform may also include its own authentication system, e.g., using a username and password unique to the unified workforce platform.

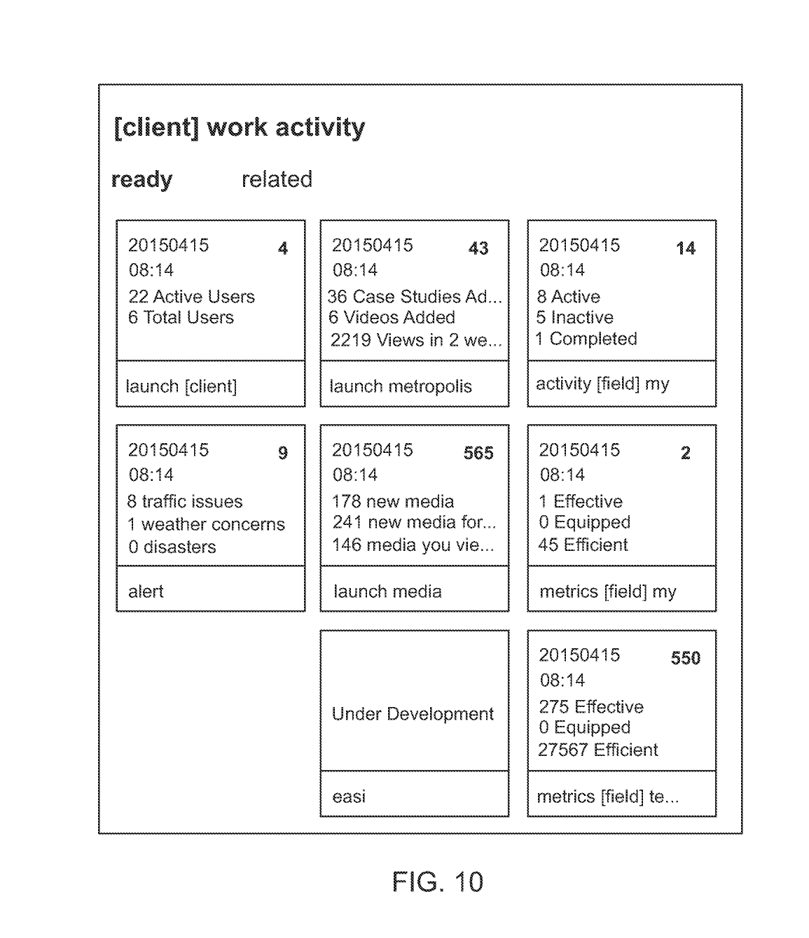

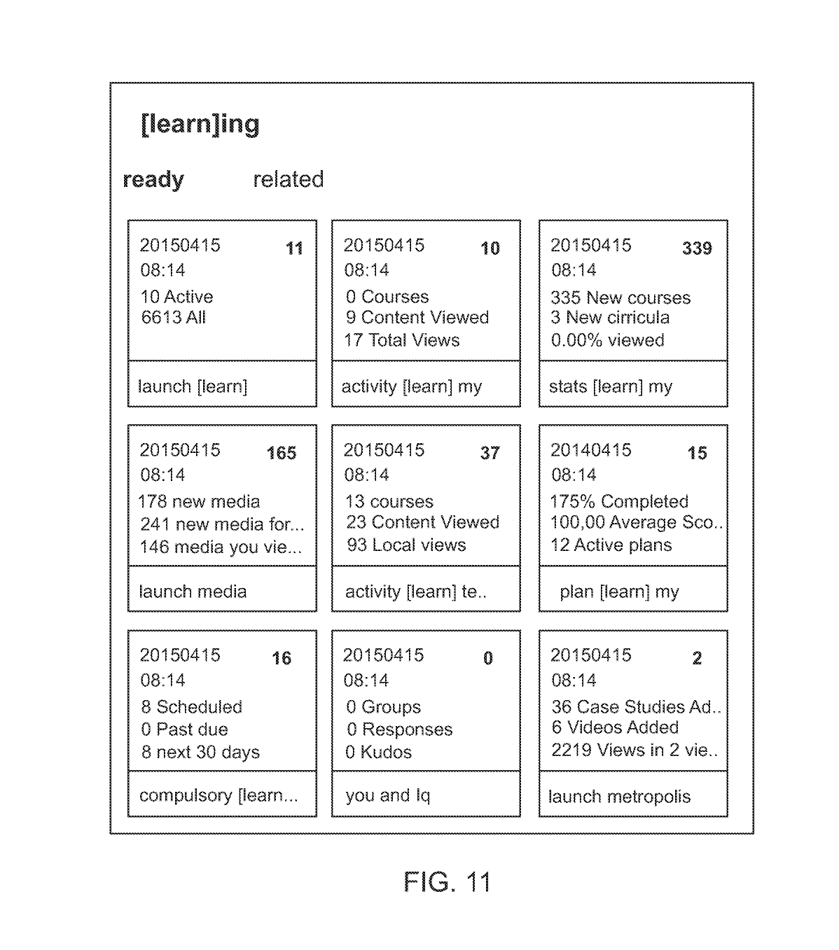

As shown in FIG. 1, an interface to the unified workforce platform may include different sections or tabs to access different interface pages and options. For example, the interface in FIG. 1 lists sections 1 as including “my rhythm,” “my role,” and “my experience,” which may be different sections of the unified workforce platform that are accessible and provide different options to a user. In the “my rhythm” section, the unified workforce platform can be configured to analyze user habits and populate with tiles based on what resources and/or tiles are most commonly accessed and/or used by the user. The tiles may also increase or decrease in size to make the more commonly used resources and/or tiles larger. Each user using the unified workforce platform may be assigned a primary role (e.g., field worker) and one or more sub-roles (e.g., health care, disease control). In the “my role” section, the user may be provided relevant tiles, resources, links, updates, news feeds, and/or other information relevant to the user's primary role and/or sub-roles. (FIG. 16 shows an exemplary “my role” section of the interface, and FIGS. 10 & 11 show exemplary “my role” related tiles, resources, updates, news feeds, and/or other information that may be provided and/or accessed via the “my role” section.) The “my experience” section may allow individual users to customize the unified workforce platform to the user's needs and/or desires. A user may be able to select relevant resources, tiles, news feeds, information, etc. of interest to the user (e.g., from a tile store/database or application store/database). A user may be able to pick and choose what tiles the user wants and arrange them in the “my experience” section interface, e.g., in a 3×3 grid similar to that shown in FIG. 11.

The interface of the unified workforce platform may also include a variety of links and/or tiles 2, which may link to various activities and/or information associated with the unified workforce platform. In one embodiment, as shown in FIG. 1, the links and/or tiles 2 may include one or more of the following: a media tile, a learning or training tile, a field tile, an alert tile, a work activity or work order tile (these may include a client generated work activity tile, a hopper work activity tile, a field work activity tile, etc.), a local labor tile, a profile tile or link, and/or other links or tiles that may be useful to one or more person using the unified workforce platform. In one embodiment, different links and/or tiles 2 may be available to different people depending on their authority and permissions levels and/or their positions. For example, an analytics tile may be provided to an administrator, but not a service provider. Also, a link and/or a tile 2 that facilitates generation of new work orders or work activities may be provided to a business owner or administrator, but not be provided to a service provider. As tiles 2 are used, the tiles 2 may automatically become larger or smaller and/or may be repositioned, for each individual user of the system, depending upon how they are used and/or how often they are used by each individual user of the system. Accordingly, the interface adapts itself to the individual users to make each user's experience customized and more convenient for the individual user. For example, the media tile in FIG. 1 is shown as the largest because the user of that interface accesses the media tile more often than the other tiles. The media tile may link to the dynamic/contextual learning module.

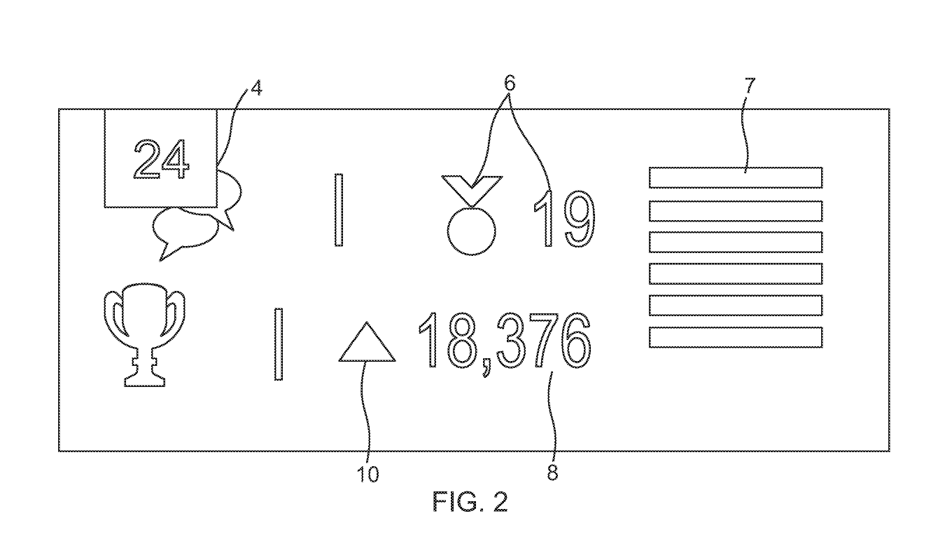

The unified workforce platform may also include a messaging bus. The unified workforce platform may allow messages to be sent between individual users of the system. The system may even allow messages to be sent to persons who are not on or do not have access to the unified workforce platform, e.g., by sending an email. Message indicator 4 may be included on the interface (and may be included on any page accessed in the system) and may provide an indication of when messages and/or emails are received. Message indicator 4 may also be a link to a user's messages. Message indicator 4 can be seen in FIGS. 1 and 2. The message bus may also provide alerts and notifications on at least the “my rhythm” interface, for example, at the notifications bar 3 and the alerts bar 5. The unified workforce platform may analyze messages and/or data associated with messages to determine whether the message requires action or does not require immediate action in response to the message. The unified workforce may provide notifications about messages that do not require action in the notifications bar 3, and provide notifications about messages that do require action in the alerts bar 5. The alerts bar 5 may change colors depending upon the urgency of the alert, e.g., red for high priority alerts that require immediate action, yellow for alerts that are important to act upon but not urgent, green for low-priority or less urgent alerts that can be handled down the road as time permits.

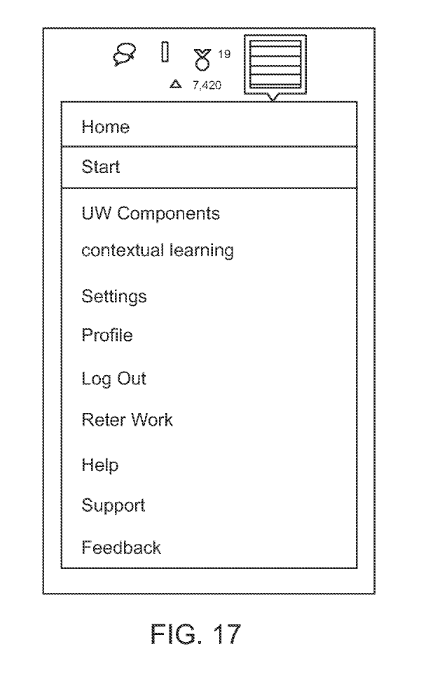

A jump bar 7 may also be provided, (the jump bar 7 is shown expanded in FIG. 17) that can notify a user when they have received a message. The unified workforce platform may also track awards, trophies, or other achievements. For example, the interface, as shown in FIG. 1, may include an achievement indicator 6 (see also FIG. 2). Achievement indicator 6 may track the number of achievements, awards, trophies, milestones etc. earned by a user. The achievements, awards, trophies, milestones, etc. may be earned for a variety of achievements. The achievement indicator 6 may also act as a link to a list of the achievements, awards, trophies, milestones etc. earned by a user and/or a list of achievements, awards, trophies, milestones etc. that a user is close to achieving or is otherwise working toward. In FIGS. 1 and 2, the icon representing the awards indicator 6 is shown as a medal, but other icons may also be used.

The unified workforce platform may also include a points engine that automatically calculates and tracks points earned and/or lost by each user. The points engine may calculate each user's points total by awarding or deducting points based on how the user performs with respect to various criteria. The interface, as shown in FIG. 1, may include a points indicator 8 that indicates the total number of points earned by each user at any given time (see also FIG. 2). The points indicator 8 may be automatically updated as new data or new points of measurement become available to the system. The interface, as shown in FIG. 1, may also include a point direction indicator 10 that indicates whether the most recent change to an individual user's points was positive or negative (see also FIG. 2). For example, if a user lost points on the user's most recent point update, the point direction indicator 10 may indicate that the most recent change to the user's points was negative. If a user gained points on the user's most recent point update, the point direction indicator 10 may indicate that the most recent change to the user's points was positive. In one embodiment, point direction indicator 10 may display as a green arrow or triangle pointing upward to indicate the most recent points update was positive and may display a red down arrow or triangle pointing downward to indicate the most recent points update was negative; although other types of icons or indicators may be used for the points direction indicator 10. The point direction indicator provides an immediate visualization of what impact the user's actions have on the user's points. The points indicator 8 and point direction indicator 10 may be visible in all or almost all screens of the platform, so users are reminded of their performance for themselves as well as how their team mates (connecting to a common office) are performing. The points engine is described in more detail below.

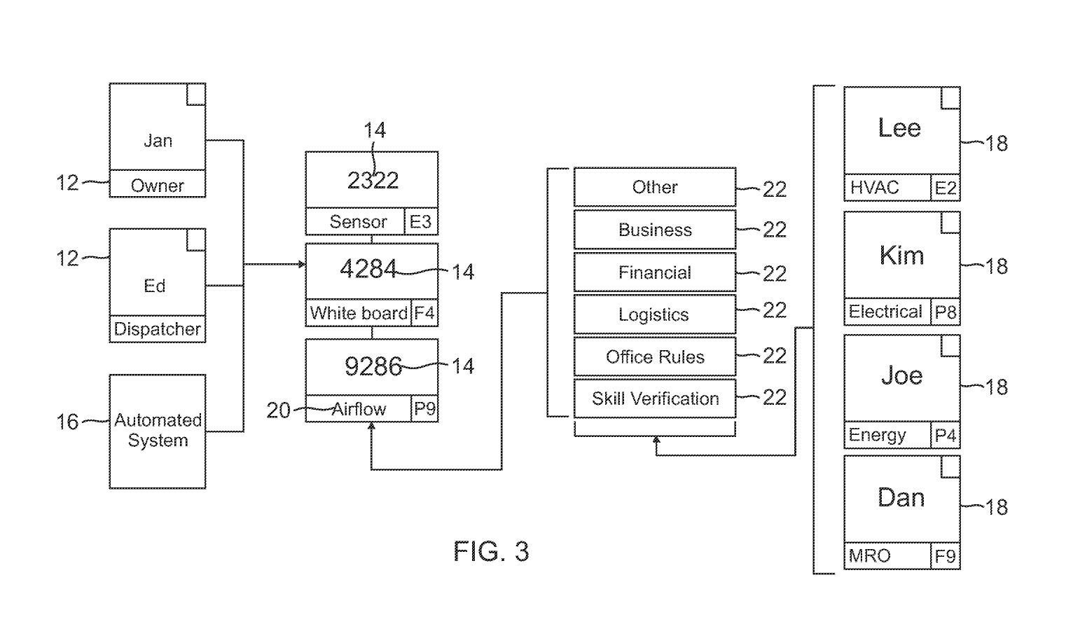

FIG. 3 illustrates an exemplary method of work distribution according to one embodiment. FIG. 3 illustrates primarily a “pull” method of work distribution (e.g., where service providers have the option to select or pull work orders or work activities they choose to complete), but the “pull” method depicted in FIG. 3 may also be used in combination with a “push” method of work distribution (e.g., where the unified workforce platform assigns or “pushes” work orders or work activities to service providers in order of a generated notification ramp, as will be discussed below) and/or a “shuffle” method of work distribution (e.g., where configuration or update information may be received by the unified workforce platform such that the unified workforce platform changes the order of what is worked on next according to the configuration or update information, the configuration or update information may pertain to available labor resources or the urgency of a particular type of work activity, for example, dealing with hurricane damage may take priority over replacing a part in a refrigerator).

In FIG. 3, work originators 12 have work projects or service requests that need to be done and generate work activity requests or work orders for the work projects and/or services that are needed. In FIG. 3, two work originators 12 are depicted, (i.e., Jan, an owner of a business, and Ed, a dispatcher); however, requests to generate a work activity may be provided to the unified workforce platform in a variety of ways and/or by a variety of people. Each work originator 12 may provide information to the unified workforce platform so that the unified workforce platform can generate one or more work requests or work orders as needed. Similarly, as also depicted in FIG. 3, work orders or work requests may also be generated automatically by an automated system or automated systems 16. For example, a sensor in a device, system, machinery, HVAC, etc. may generate a signal that indicates a malfunction, problem, issue, and/or a malfunctioning part, device, system, etc. The sensor may cause a work order or work activity to be generated to address or repair the malfunction, problem, issue, etc. identified by the sensor. For example, a computer program run on a computer or computing system (e.g., a cloud computing system) may receive the signal from the sensor and cause a processor automatically to generate a work order, work request, or work activity to address the problem/issue indicated by the sensor signal. Optionally, a service/maintenance schedule may cause regular maintenance work orders, work requests, or work activities automatically to be generated as scheduled or periodically. Accordingly, work orders/requests/activities for services and/or work projects may be generated automatically by machines, sensors, computers, computing systems, etc., e.g., those that that monitor equipment, devices, systems, conditions, etc. In one embodiment, work orders/requests/activities based on automated service requests and/or work projects may be generated for use under a “pull” method, “shuffle” method, and/or “push” method of work distribution.

Three work activities 14 are depicted as having been created based on work orders or work requests from work originators 12 and/or automated systems 16, including work activity 2322 to service a malfunctioning sensor, work activity 4284 to fix a problem with a whiteboard, and work activity 9286 to address an airflow problem (e.g., an HVAC issue). Generally, the terms “work activities” or “work activity” are used herein to describe a work project request or work order as formatted for the management system (e.g., for the unified workforce platform) based on input provided to the unified workforce platform (e.g., from a work originator and/or one or more sensors). The work activity may include associated information used by the management system, e.g., criteria or requirements 22. Work activities may be generated by the unified workforce platform as a result of input (e.g., a corporate employee entering information via a web portal or a specified website, or one or more sensors automatically providing information based on recorded data) Optionally, the system or unified workforce platform may generate the work activities in the correct format for the system or unified workforce platform based on information input by work originators and/or based on information received from a client's system. In one embodiment, work originators may generate work orders or work project requests on a client's system (e.g., a transactional system), and the unified workforce platform may pull the work orders or work project requests and/or information about the work orders or work project requests from the client's system. The unified workforce platform may use the work orders or work project requests and/or information about the work orders or work project requests from the client's system to generate work activities in the format used by the unified workforce platform and including the information used in the unified workforce platform. The system or unified workforce platform may convert work orders from a client or information from a client into work activities to be used by the system or unified workforce platform.

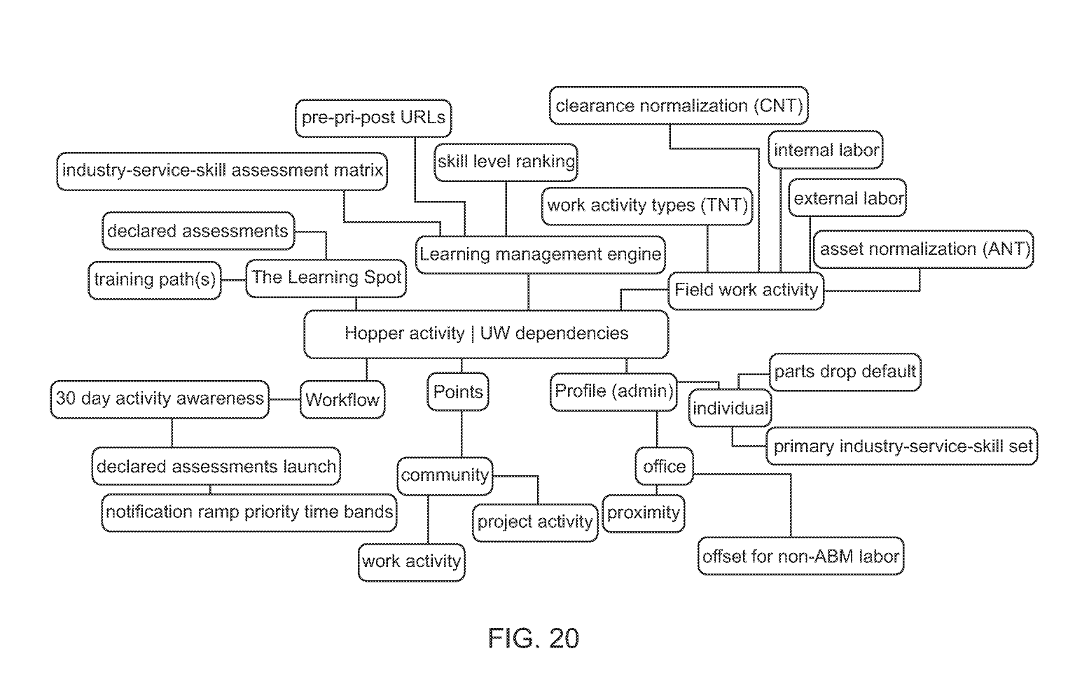

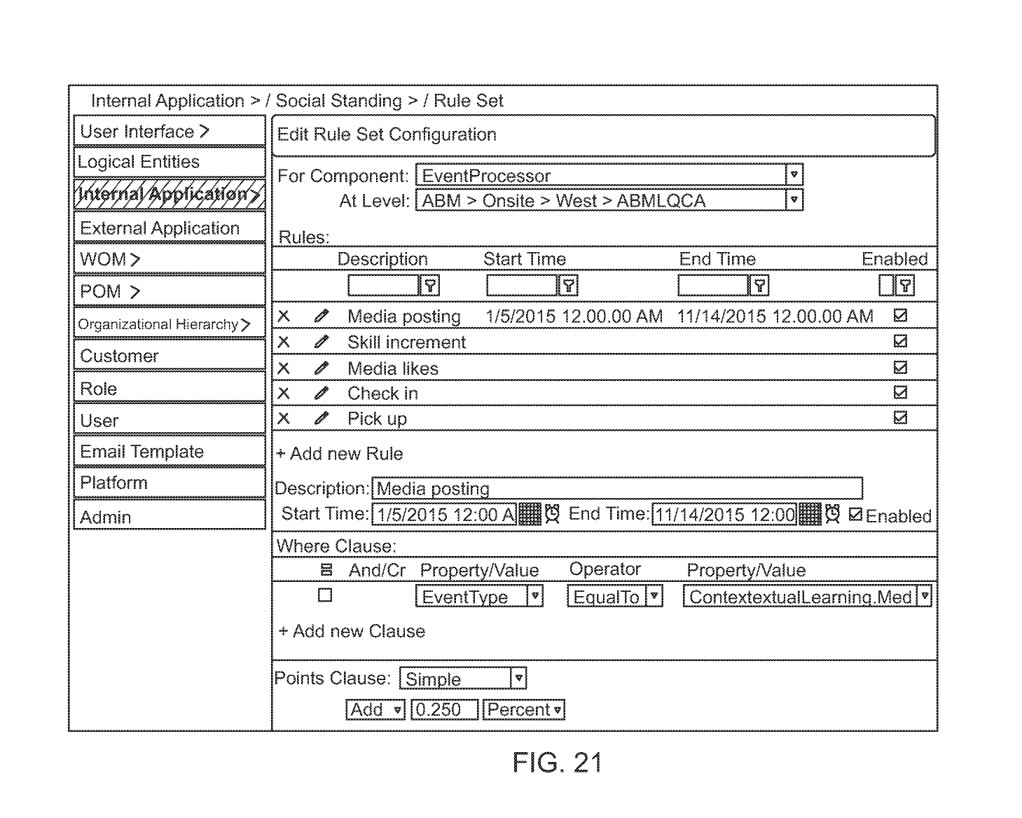

Any type of work activity 14 to address any type of work project and/or service request may be generated by or based on information from any type of work originator or work originating system (e.g., automated system 16). The work activities 14 are depicted as having populated in a hopper logic 20. Hopper logic 20 may be virtual and may be a portion of the system that includes memory and may store and/or process information regarding a variety of work orders and/or work activities until the work orders and/or work activities are paired with a service provider and/or are completed. The hopper logic 20 may be the location that many of the functions described herein take place, e.g., generating a work activity based on a work order or information from a client's system, associating criteria or requirements 22 with a work activity, matching a work activity to a pool of candidates that are qualified to complete the work activity, applying criteria or requirements 22 to determine qualified/eligible candidates, analyzing points, establishing a notification ramp or schedule, awarding/deducting points, notifying qualified/eligible candidates about work activities, verifying training, and/or others. For example, FIG. 20 shows many features and activities that may be managed by and/or may influence the hopper logic 20.

Work activities 14 may be categorized or aligned into a variety of different components or criteria to help ensure that the work activity ends up assigned to a service provider competent to handle the work activity or service request. In one embodiment, work activities 14 maybe categorized according to one or more of the following components/criteria: industry, service, and skill. Industry categorization may be used to ensure that a service provider within the correct industry or field to address the type of problem, issue, service, activity, etc. receives the work activity 14. For example, a work activity categorized for automotive will not be given to a service provider who only fixes personal computers, a work activity categorized for biopharmaceutical industry will not be given to a service provider in automotive, etc. Service categorization may be used to ensure that the right service provider within the industry for the particular service or activity needed receives the work activity 14. For example, a work activity to address an engine problem may be given to an engine specialist as opposed to a tire specialist within the automotive industry. Alternatively, the unified workforce platform may be configured to automatically select the category. Using the example above, if a request for generation of a work activity is directed to a check engine light, the unified workforce platform may be configured such that the selected issue, “check engine light on,” corresponds to the automobile category. Similar examples may be done with other maintenance signals.

Skill categorization/criteria may be used to ensure that a service provider that has sufficient skill within the industry and service area to successfully complete the work project or work order described in the work activity 14 receives the work activity 14. A requisite skill level necessary to adequately address the work project or work order may be assigned to each work activity. A variety of scoring or indicating systems may be used to indicate the skill level required for a given work project, service, or activity. In one embodiment, one or more of the following skill group categorizations may be used: Fundamental, Proficient, and Expert. Fundamental skill level (which may be designated by “F”) may correspond to a basic level of skill/understanding in a service area of an industry, Proficient (which may be designated by “P”) may correspond to an average or mid-range level of skill/understanding in a field, and Expert (which may be designated by “E”) may correspond to an high or expert level of skill/understanding in a field. For example, while many service providers may have a fundamental or proficient level of skill in HVAC, some problems may be so complicated that they require expert level skill to complete; in these cases, one must ensure that a service provider with high level or expert skill is paired with the work activity, instead of someone who does not have the skill to address the particular issue. Categorizing work activities in the above ways helps ensure that the right person is in the right place at the right time to address any work projects or issues that arise. In another embodiment, the skill/understanding in a service area may be represented by a numerical number, which may be termed a “score.” For example, a service provider may have a score of 95 (e.g., score may range from 0-100) in a particular field (e.g., wherein a higher score represents a higher level of skill/understanding in a field than a lower score).

Within each of the categorizations discussed above, sub-categorizations may occur. For example, within the skill categorization, the overall skill groups of Fundamental, Proficient, and Expert may be combined with skill level sub-categorizations within the overall skill groups. In one embodiment, skill level sub-categorizations may be assigned on a scale of zero through nine (or on a scale of one through ten). For example, in FIG. 3, work activity 4284 requires a skill level of at least “F4,” which corresponds to a fundamental skill level 4, work activity 9286 requires a skill level of “P9,” which corresponds to a proficient skill level 9, and work activity 2322 requires a skill level of “E3,” which corresponds to an expert skill level 3. In these categorizations the letter “F” corresponds to the fundamental skill group, “P” corresponds to the proficient skill group, and “E” corresponds to the expert skill group, whereas the numbers correspond to the sub-categorization skill level within each skill group. Using this or similar skill level categorizations helps to ensure that the service provider that is paired with a work activity has the requisite skill to properly complete the work activity or project.

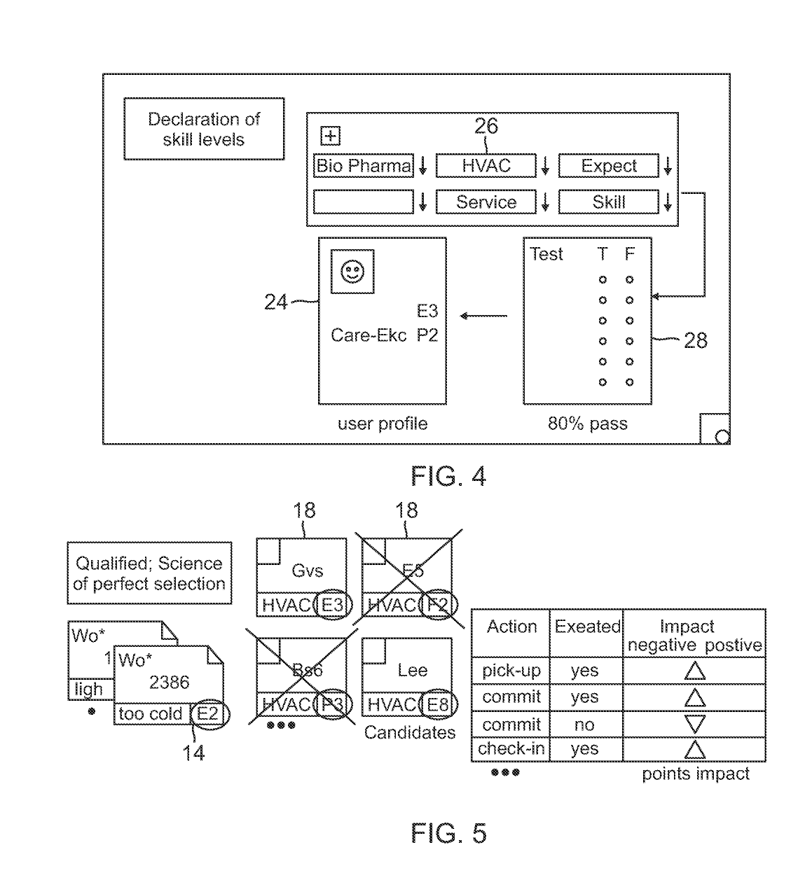

As service providers 18 join the unified workforce platform or later update their information, they may each create or update a user profile 24 with information about themselves. As part of that process or as part of another qualifications or evaluation process, the service providers 18 may be given the opportunity to declare the industries, service areas, and/or skill level they believe they qualify for. For example, FIG. 4 shows an exemplary declaration of skills webpage. Window 26 in FIG. 4 shows an exemplary format in which a user (e.g., a service provider) may enter one or more industries, one or more service areas, and one or more skill levels, e.g., window 26 shows a first line entry indicating the user believes he/she has an expert level of skill in an HVAC service area in a Biopharma industry, and second line that is not yet filled in that says industry, service, and skill to indicate what information should be entered in each box. The user may enter the skill level the user believes he/she possesses for each service area in each industry. The skill level entered may be verified through the unified workforce platform.

Service providers 18 or other participants using the unified workforce platform may be evaluated or qualified for a particular skill level within a service area of an industry. Similarly, if a skill level has been entered by a user or service provider, then the skill level may be verified. Evaluations or verifications may take a variety of forms including, for example, practical and/or written assessment tests. FIG. 4 shows an evaluation test or a link to an evaluation test 28. Service providers and participants 18, depending upon their performance on assessments/evaluations service area in an industry, may be placed at a skill level sub-categorization based on a scale of zero through nine (or a scale of one through ten) within each skill group. The skill levels may be associated with the user's profile 24. In one embodiment, skill level categorizations may correspond to scores on an assessment evaluation. For example, if a service provider scored a 94% on his or her assessment, the service provider may be given a skill level of E4 (corresponding to an expert skill level 4), whereas if a service provider scored 82% on his or her assessment, the service provider may be given a skill level of P2 (corresponding to a proficient skill level 2).

In one embodiment, different evaluation tests 28 may be automatically provided by the unified workforce platform to test expert, proficient, or fundamental skill levels in the various service areas of the various industries upon providing information to the unified workforce platform through, for example, the declaration of skills webpage of FIG. 4. For example, if a user identifies his/her skill level as being expert in a particular service area of an industry, a first test may be generated or used to test whether the user in fact qualifies at an expert level for that service area and industry. Similarly, if a user identifies his/her skill level as being proficient in a particular service area of an industry, a second test (different from the first test) may be generated or used to test whether the user in fact qualifies at a proficient level for that service area and industry. If the user identified his/her skill level, but does not pass the test for that skill level (e.g., does not obtain a requisite percentage of correct answers, e.g., 70% or 80%), then the user will not qualify for that skill level. If a user does not pass the test at one skill level, the user may be automatically prompted to take another evaluation for a lower skill level (e.g., if a user fails the expert level test, then the user may take the proficient level test). If a user does pass the skill level test, the user may be automatically sub-categorized within the skill level based on the test results. In one embodiment, the skill levels may be assigned as shown below in Table 1. For example, a user with a score of 87% on the expert level test may be set at an E3 skill level, but a user passing the expert level test with 92% may be set at an E6 skill level. Other scoring conventions and skill level assignments may also be used.

TABLE 1

| Assessment | Skill Level |
|---|---|
| Test Score | Categorization |
| 99% | E9 |
| 98% | E9 |
| 97% | E8 |
| 96% | E8 |
| 95% | E7 |
| 94% | E7 |
| 93% | E6 |
| 92% | E6 |
| 91% | E5 |
| 90% | E5 |
| 89% | E4 |
| 88% | E4 |
| 87% | E3 |
| 86% | E3 |
| 85% | E2 |
| 84% | E2 |
| 83% | E1 |
| 82% | E1 |
| 81% | E0 |
| 80% | E0 |

FIG. 3 depicts several different users/service providers/participants 18 (there may be any number of users/service providers/participants using the system) with various skill levels in various service areas. For example, Lee is shown as having an “E2” skill level in HVAC, Kim is shown as having a “P8” skill level in electrical, Joe is shown as having a “P4” skill level in Energy, and Dan is shown as having a “F9” skill level in maintenance, repair, and operations (“MRO”). While only one representative skill level for a given service is depicted for each service provider/participant 18 in FIG. 3, each service provider/participant 8 may have many different skill levels in many different service areas in many different industries associated with the service provider/participant's profile on the system. For example, a general MRO person may be rated with at least a fundamental or proficient skill level in a variety of service areas for maintaining or servicing a variety of devices, systems, etc., but not qualify as an expert in many of the service areas. For example, a general MRO person may be rated to address HVAC issues that F9 skill level or below, but not be qualified for highly specialized HVAC repairs that require, for example, an E2 skill level.

In a “pull” method of work distribution, service providers/participants 18 who qualify for a work order or work activity may decide whether to take the work order or work activity, whereas in a “push” method of work distribution the unified workforce platform decides who will be assigned to complete a work order or work activity and pushes/assigns the work order or work activity to a particular service provider. In a “shuffle” method of work distribution, a client or other person may provide the unified workforce platform with additional information and, based on the additional information, the unified workforce platform shuffles or prioritizes work activities to ensure that certain work activities are addressed first, but “shuffle” may be used in combination with a “pull” method to ensure work activities are assigned in a timely manner as desired. In “shuffle,” the hopper logic 20 may respond to priority changes made by a client by modifying the notification ramp/schedule to users (e.g., service providers) to make sure high priority work activities are sent out first. Then a user is more likely to pull the high priority work activity before lower priority work activities.

To qualify for a work activity, the user/service provider/participant 18 must satisfy certain criteria or requirements 22. For example, if a service provider 18 does not satisfy one of the criteria or requirements 22, then the service provider 18 may be excluded from even viewing the work activity, i.e., the work activity does not appear as a possible work activity to be pulled for that service provider 18. In other words, a service provider/participant 18 might only be allowed to view and/or select work activities 14 for which the service provider/participant qualifies under the criteria or requirements 22. If a service provider/participant 18 does qualify for a work activity 14, then the service provider/participant 18 may “pull” or select the work activity 14 from the 20. By using criteria or requirements 22, the unified workforce platform may also help ensure compliance to organizational and regulatory standards to help limit exposure to risks that can result in injury (i.e., compliance ensures a safer working environment for workers), complications, and/or loss (e.g., financial or productivity loss).

Once a work activity 14 is selected and/or accepted by a service provider/participant 18, the work activity 14 may no longer be available to other service providers/participants, unless the work activity 14 requires a team of service providers/participants. In one embodiment, the unified workforce platform may automatically designate that a particular work activity requires a team of service providers based on the nature of the call of the work activity. If a team of service providers/participants is required for a work activity 14, then the work activity may have several service provider team slots associated with it, and individual slots may be accepted by various service providers/participants 18. If different types of skills are required for a work activity 14, a team of service providers of different backgrounds, experience, skill levels, etc. may fill the team slots as required for the work activity. Allowing users (e.g., service providers, field personnel, etc.) to “pull” their own work orders/activities or slots on a team (and influencing positive behavior as discussed elsewhere herein) allows intuition to enter into routing and work distribution. Additionally, the unified workforce platform may automatically optimize the paths of service providers based on traffic patterns, real-time traffic feeds and “known” problems areas to improve efficiency.

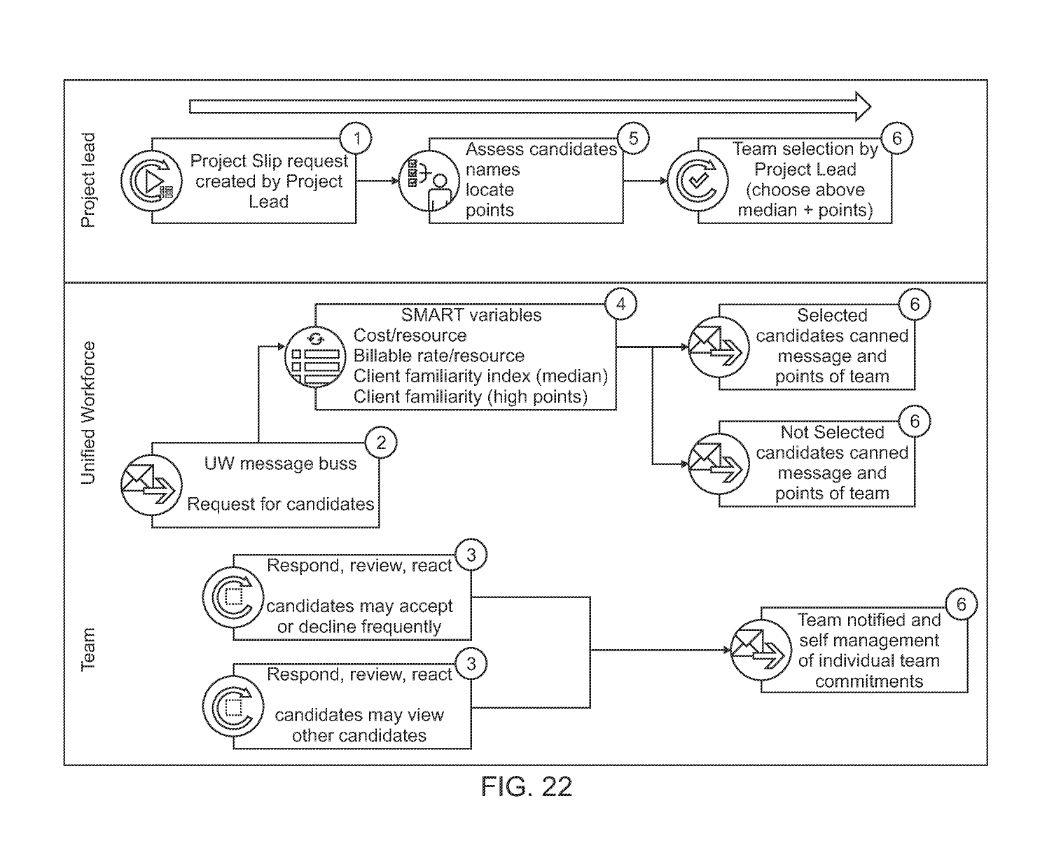

Optionally, teams may be formed, for example, as depicted in FIG. 22. As shown in FIG. 22, a project slip request may be created by a Project Lead (or person in charge of the team project). Then the unified workforce platform or hopper may look for possible candidates and applies at least some criteria or requirements 22 to determine a pool of candidates that would be qualified for the work activity. The unified workforce platform or hopper may also look at other variables or other criteria or requirements 22 to determine the qualified candidates the best meet client preferences. Qualified candidates may be able to view the work activity or project slip and other candidates to determine if they are interested in the work activity or project slip. The Project Lead may receive a list of candidates generated by the unified workforce platform (e.g., the top five service providers according to the notification ramp for a particular work activity may be presented as candidates), candidate qualifications and/or other information. The Project Lead may then select the team desired via input into the unified workforce platform. Once team members are selected, the unified workforce platform may automatically message the team members to let them know they have been selected for the team and/or provide them information about the work activity or project. The unified workforce platform may also automatically message candidates that were eligible and/or interested in the work activity, but were not selected. The project lead may be awarded and/or deducted points based on the team members selected (e.g., may have points deducted for selecting team member with fewer points and/or qualifications).

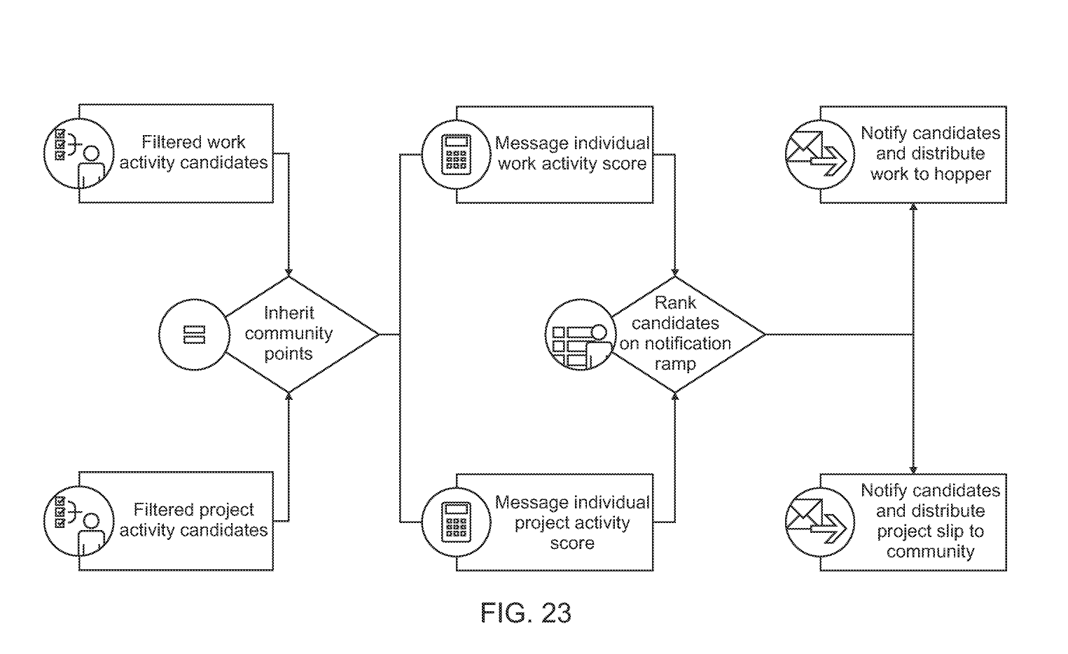

FIG. 23 shows an exemplary side-by-side model for how individuals may be paired with work activities and how team members may be paired to a team project or project slip. In either case, the users of the system may be filtered to form a pool of qualified candidates based on one or more of criteria or requirements 22. Individual user points and a tally of the total points of the pool of candidates may be collected, e.g., a snapshot of points at the time of the work activity may be taken. Then points may be massaged according to various variables, criteria, and/or requirements as desired (e.g., as desired by the client). For example, the points of individual users may be increased or decreased somewhat to meet the preferences of the client. Then a notification ramp or notification schedule is formed and user are notified and provided with information, e.g., the project slip or work activity is distributed to the users based on the notification ramp/schedule.

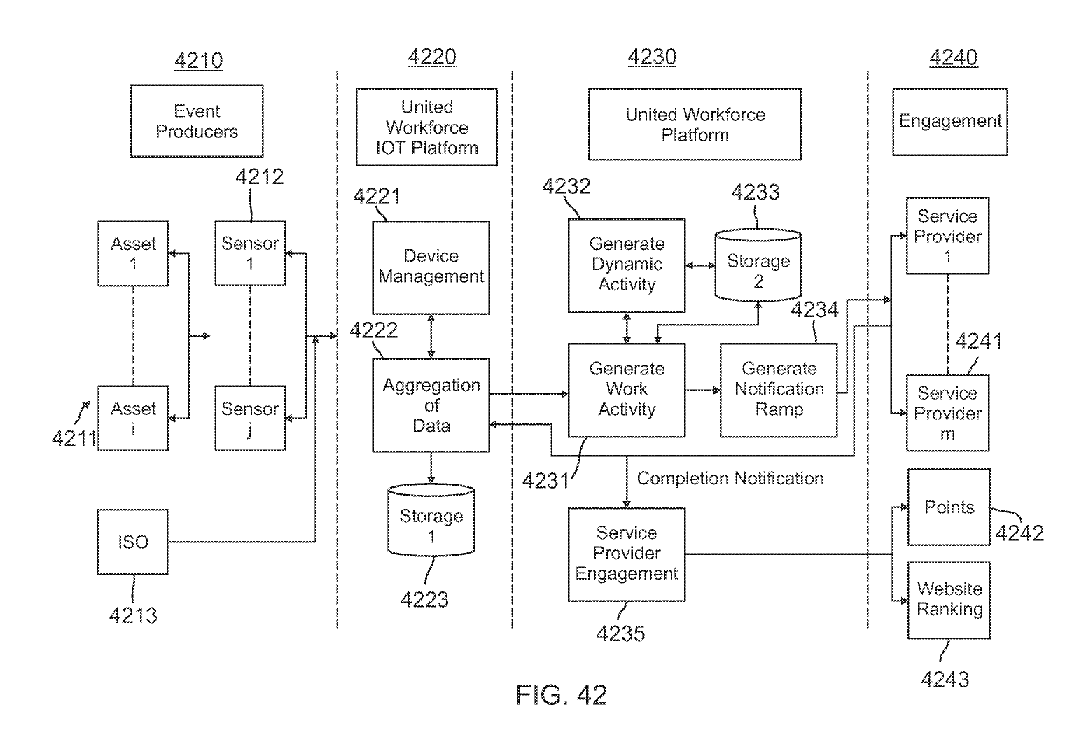

The criteria or requirements 22 to qualify to see and/or select a work activity 14 may include skill verification, office rules, logistical rules, financial rules, business rules, training, and other requirements or rules. Skill verification may involve skill level requirements (e.g., E3, P9, F4, etc.) associated with work activities (as described above), and the service provider's skill level must match the minimum skill level required for the required service in the required industry. Sub-certifications or verifications of other skills, experience, and/or training may also be required. Logistics or logistical rules may include a requirement that the service provider be within a geographical area or within a certain proximity to the site that requires the work activity/project in the work activity 14. Other logistical rules may also apply. Various financial rules or requirements may apply. For example, a requirement may be placed on the work activity 14 setting a maximum price the requestor is willing to pay for completion of the work activity. Other financial rules to determine the best valued service provider for the work activity 14 (e.g., including billing rates, cost of a resource, travel costs, etc.) may also be applied. Various business level rules or requirements may also be applied. For example, a company or work originator 12 may have specific business policies associated with a work activity. For example, a company or work originator 12 may wish to give preference to internal employees receiving a work activity 14 over service providers or contractors external to the company. Training requirements may also be used. For example, a service provider may be required to complete certain safety courses or programs before being eligible for a work activity. Requirements may include confirmation of compliance items, licenses, and/or certifications. A wide variety of other requirements or rules may also be associated with individual work activities or groups of work activities 14. Criteria or requirements 22 may be used by the unified workforce platform in filters and algorithms to analyze and figure out who is best suited or what pool of candidates is best suited for a work activity or work order. Herein, the rules discussed above may be stored within a local or remote database (e.g., storage 4223 or storage 4233 in FIG. 42) or cloud computing resources. The unified workforce platform may apply one or more of the rules to each received request for the generation of a work activity (e.g., a portion of the rules may not be applicable to some work orders based on the nature of the call).

Criteria or requirements 22 may be used to wholly eliminate unqualified candidates. Also, criteria or requirements 22 may optionally be used to adjust the notification ramp and thereby adjust when specific users are notified about a new work activity or work order. For example, criteria 22 may include variables such as billable rates, cost of a resource, travel costs, client familiarity, etc. that may feed into filters and algorithms to figure out who is best for job and/or when they should be notified. The notification ramp may be formed by analyzing points of individual users, total points of a candidate pool, and applying discounts or additions to user points based on various criteria or requirements 22. In one embodiment, a local labor contractor may have the ability to manipulate their position on the notification ramp (discussed in more detail elsewhere herein) by becoming more competitive from a billable rate perspective, e.g., by lowering their billing rate or another variable, the contractor may be able to qualify for earlier notifications of work activities. Herein, according to configuration input (initial or updates) received by the unified workforce platform from one or more administrators for example, the unified workforce platform may discount the points of otherwise qualified candidates whose billing rates are too high. By lowering the billing rate, the points will not be discounted as much, which may lead to earlier notification on the notification ramp. The hopper logic 20 may automatically and/or in combination with a human selector or decision maker may arrange for or deny team members to form the perfectly assembled technical and cultural project teams.

In one example, ten qualified work candidates may be left after business and logistics filtering criteria or requirements have been applied by the unified workforce platform, including five local labor candidates and five non-local labor candidates. An administrator, e.g., via an administrative portal, may have provided input such that the unified workforce platform set local labor to have a point bonus of 50%. (Each client may have its own web instance of the unified workforce platform and may administer aspects of the unified workforce platform relevant to the client via its web instance.) As part of establishing the notification ramp, 50% of each local labor candidate's points are added to the candidate's point total (but the five non-local labor candidates do not receive the bonus and are left at their true or original point level). As a result, the local labor candidates' points change dramatically for the work activity, which moves local labor candidates along the notification ramp to an earlier notification time and allows them to have first right of refusal.

After all the criteria and requirements 22 have been applied to the work activities 14 and the service providers/participants 18, a certain number of service providers/participants 18 may be allowed to see, be associated with, and/or select various work activities 14 for which they qualify. Service providers/participants 18 may then be allowed to select which work activities they wish to accept or decline of the subset of work activities 14 for which they qualify. If a work activity is not selected by any of the service providers/participants 18 or if a particular service provider/participant is desired for a work activity, then the system may be used in a “push” method format to automatically assign a work activity to a particular service provider/participant (e.g., after a predetermined amount of time has expired following the creation of the work activity).

FIG. 5 illustrates one example of how criteria or requirements 22 may be used to match the right person with the right job. As can be seen in FIG. 5, work activity number 2386 includes a “too cold” HVAC-related service request that requires an “E2” skill level to properly handle. Of the users/service providers 18 shown in FIG. 5, only two (i.e., Gus and Lee) have a skill level at or above “E2” in the HVAC service area, so only those two (Gus and Lee) may be allowed to see and/or accept work activity number 2386. Validation of skill levels as associated to work activity types may be performed in real time during work distribution process.

As discussed above, the unified workforce platform may also include a points engine that calculates and tracks points earned and/or lost by each user. The points engine may calculate each user's points total by awarding or deducting points based on how the user performs with respect to various criteria. For example, various objective points of measurement may be used, e.g., key performance indicators and/or other business measurement points. Optionally, various subjective points of measurement may also be used, e.g., points may be awarded to a service provider based on how one or more customers rank their experience with the service provider. In one embodiment, the criteria for which a user may receive points may include various efficiency measures, effectiveness measures, client interaction measures, follow up, responsiveness measures, information sharing, training, and/or other measures and interactions. For example, a service provider may receive positive points for arriving on time at a location where the work activity is required, but may receive negative points, if the service provider is late (e.g., more than 10 or 15 minutes late). If points are deducted for being late, the amount of points deducted may change based on how late the service provider arrives (e.g., 10 minutes late may result in a loss of 10 points, 20 minutes late may result in a loss of 20 points, and so on). A service provider may also receive additional points for completing a work activity on time or ahead of schedule, and/or may lose points for taking too long to complete a work project. In one embodiment, the unified workforce platform may allow a user to run an application on a mobile phone or other mobile computing device (as discussed in more detail below), and the user may be able to check in on arrival and check out on completion of a work activity using the application on the user's mobile phone or other mobile computing device. The unified workforce platform may then be able to automatically calculate whether the user (e.g., a service provider) arrived on time and how long it took to complete the work activity. In one embodiment, more than 100 activities, variables, and/or criteria may result in points being added or deducted from a user's point total.

Data on the various criteria or points of measurement may be supplied to the points engine automatically, manually, or in some embodiments, a combination of both. The points engine may analyze data on the unified workforce platform and/or information gleaned from third party sources or websites. The points engine then uses associated memory and one or more processors to parse the data and make decisions about whether the data and/or various criteria or points of measurement should have a positive or negative impact on a user's point total, and the points engine automatically awards or deducts points from the user's point total based on the data and/or various criteria or points of measurement. For example, a user may be awarded a certain number of points every time they accept or commit to a work activity. Optionally, user may have a certain number of points deducted for each work activity that they decline or to which they do not respond (e.g., a user may lose a certain number of points if they do not respond to a new work activity within a certain amount of time, e.g., 30 min, 1 hour, 1 day, etc.).

The table on the right side of FIG. 5 shows a series of actions for which points may be added or deducted. In the table in FIG. 5, picking up a work activity results in positive points, committing to a work activity also results in positive points, and checking in also results in positive points. However, forgetting to commit to a work activity within a timeframe dictated by the work activity priority level results in negative points.

The points system may help to create a socially influenced community that influences individual users to increase or decrease the user's points, e.g., a first user seeing that second user has more points than the first user, may cause the first user to be socially motivated to increase the first user's point total. Individual users may compete to gain more points than other users. In addition to the general social influence to increase points, as discussed in more detail below, there is an additional incentive to increase points because users with more points will be notified of new work activities or work orders before users with fewer points. Accordingly, users with more points will have better choices about which work activities or work orders to accept and which to decline. This adds a practical incentive to seek the most points possible. Further, there are significant social incentives for a user interacting with or being influenced by other persons on the unified workforce platform to work their best and earn as many points as possible. As a general rule, any positive behavior may be rewarded by adding points and any negative behavior may cause points to be deducted from a user's total. Therefore an environment may be provided in which positive behavior is encouraged and negative behavior is discouraged.

The unified workforce platform may also include an administrative portal that may allow an administrator of a company to provide the unified workforce platform with configuration or update information such that the unified workforce platform adjusts the amount of points awarded and/or deducted for various activities or behaviors (e.g., the unified workforce platform generates rule based on the configuration or update information). For example, a company or an officer of a company may decide that arrival on time to a work activity needs work among the service providers in the officer's organization and may add more points for checking in on time upon arrival at a worksite (e.g., the unified workforce platform generates a rule based on arrival time for adjusting the points awarded to a service provider). Later the same company/officer or another company or an officer of another company may decide that they want to encourage users to build institutional or shared knowledge, and may decide to award more points for sharing contextual knowledge and/or instructional media (e.g., pictures, instructions, videos and/or audio files) for how to more effectively or efficiently address particular work activities, repair equipment, etc. (e.g., the unified workforce platform generates a rule based on uploaded information to the learning portion of the unified workforce platform as seen in, for example, FIG. 1, for adjusting the points awarded to a service provider). This may build the institutional or shared knowledge as other users can access the media and learn better ways to address the particular work activities, repair certain equipment, etc. There are many ways in which the points engine and points system can be massaged or changed in different ways to incentivize or disincentivize a variety of behaviors. An iterative process of identifying opportunities for improvement through corrective and preventive actions gives an organization the ability to get better in the delivery of products and services to internal (peers) and external customers.

Each organization may have its own web instance or share a web instance of the unified workforce platform and may use an administrative portal to customize the points and target behaviors important to that organization. Optionally, a group of organizations may share accesses to a unified workforce platform (e.g., so they can share certain media or other institutional knowledge with each other, so they can collaborate and form teams to better meet client needs, and/or for other reasons). In such a case, one or more administrators may have access to certain rights through one or more administrative portals, and may be able to massage/change points earned/lost for their own organization/users/employees alone, and/or may be able to collaborate or agree with other administrators to massage or change the points earned/lost by all users for various behaviors and/or activities. Optionally, only one administrator for the group of organizations may be appointed or chosen to have access to an administrative portal or change aspects of the system, including how many points are added or deducted for various behaviors/activities.

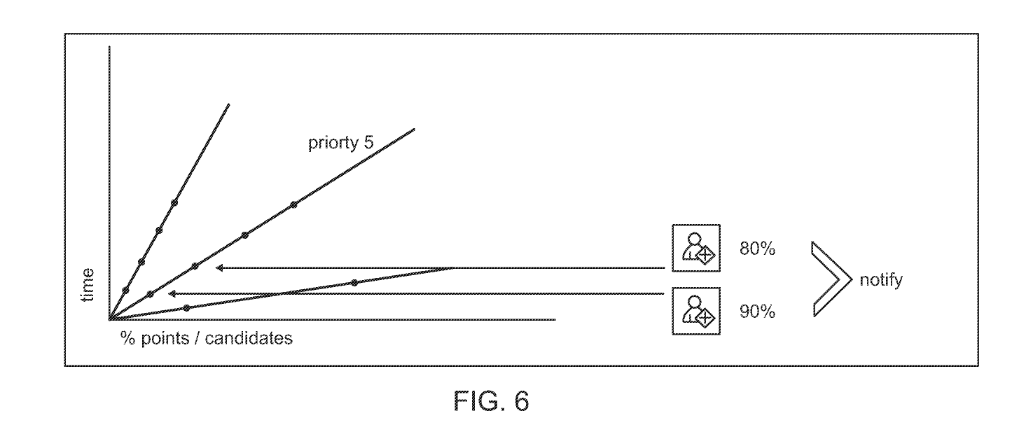

FIG. 6 shows a graph indicating how a user's point total may influence when a user is notified of new work activities 14. In FIG. 6, the Y-axis represents time from a work activity entering the hopper 20 (i.e., the lowest point on the time axis) to the time all relevant users/candidates (i.e., the user/candidate must qualify for viewing a work activity as discussed above, or the user will never see the work activity) are notified about a work activity 14 (i.e., at the top of the Y-axis). The X-axis represents a measure of points, e.g., the percentage of points a user has relative to the combined total of all points, the total number of points each candidate (i.e., each user eligible for the work activity based on criteria or requirements 22) has, the percentage of points a user has relative to the combined points of the pool of candidates (i.e., pool of eligible users) for a given work activity. The most prominent diagonal line or notification ramp/notification priority line (listed as “priority 5”) on the graph shows when users of different point levels or percentages of points are notified of work activities after they are generated and/or enter the hopper. A user (e.g., a service provider) having more points may be notified of new work activities at an earlier time than a user with fewer points, and thereby have the opportunity to accept or decline the work activity before the user with fewer points. A user with the most points may be the first user to receive notification of a new work activity, so that user will have the first opportunity to accept or decline a new work activity. Optionally, the notifications may go out in batches, e.g., all the users in the 90^{th} percentile of most points may be notified together in the first instance or first batch, then all users in the 80^{th} percentile of points may be notified together in the second instance or second batch, then all users in the 70^{th} percentile of points may be notified together in the third instance or third batch, and so on. Optionally, the notifications may go out on a continuous scale (rather than in batches), e.g., where a first user with the most points is the first to be notified, a second user with the second most points is notified later but before anyone other than the first user (even though both are in the top 90^{th} percentile of points), a third user with the third most points is notified later but before anyone other than the first and second user, and so on, and the user with the least points is the last to receive notification.

The notification ramp or notification priority line may be established and/or adjusted or in various ways to customize the amount of time between sending notifications to users, e.g., to customize how much time passes between each user (or each group or batch) being notified. In one embodiment, one or more administrators with access to an administrative portal may enter preferences and/or adjustments to customize the how the notification ramp/schedule will be set for new work activities. In one embodiment, each work activity may have a notification ramp or notification priority line with a different slope or “priority” depending on various factors, including, for example, how urgent or time-sensitive a work activity is. For example, a first work activity may have a priority level 5 (e.g., as shown with the dark diagonal line in FIG. 6) with a first slope, a second work activity may have a priority level 2, and a third work activity may have a priority level 8 (e.g., the lighter diagonal lines in FIG. 6 represent other notification ramps with different priority levels established for other work activities) with a second slope different from the first slope, such that eligible users are notified at different times for the first work activity compared to the second work activity. Optionally, groups of users may be categorized according to different priority levels, which may provide different timing for notifications.

In one embodiment, after qualification criteria or requirements for a work activity are applied by the hopper, a pool of candidates who are qualified to do the work activity may be identified by the hopper. Then the hopper may take a snapshot or frozen tally of the total combined points of all the qualified candidates, and any modifications to the point totals based on client preference and/or other criteria or requirements may be applied, e.g., for a client that prefers its own employees, non-employee labor may have their points discounted in favor or client employees and/or client employees may receive a bonus to their points that non-employee or contractor labor does not receive. Once any adjustments to point totals of individuals have been applied, the hopper establishes a notification ramp or priority line schedule, and notifications are sent out according to the schedule.

By having the above described point system or a similar system, the unified workforce platform may be used to incentivize positive behavior and disincentivize negative behavior as discussed above. Users (e.g., service providers) will be motivated to act positively so as to gain more points and limit losses of points, so that the users can have more points than other users and be notified of new work activities at an earlier time. Receiving earlier notification allows the users with the most points to accept the best work activities while passing the less desirable work activities down the chain to users with fewer points. Thus, receiving earlier notification will be desirable and help motivate users to increase their point totals, which in turn requires them to improve their positive behaviors and limit their negative behaviors. As discussed above, one or more administrators may be able to provide input to the unified workforce platform (e.g., configuration or update information) that enables the unified workforce platform to generate one or more rules to automatically adjust the points awarded or lost/deducted for various activities to guide behaviors in the direction needed or desired for a particular organization or group of organizations.

The unified workforce platform may also include a workflow module or activity awareness module that periodically (e.g., weekly, bi-weekly, monthly, every 30 days, bi-monthly, etc.) sends a notification (e.g., an automatic notification) informing individual users of how many work activities they were allowed to see during the period and how many work activities they missed out on seeing and/or selecting and why the users missed out on seeing and/or selecting the work activities. For example, a first user might be notified that a certain number of work activities for which he/she would have been eligible were accepted by other users before the first user was even scheduled to receive notification based on the notification priority of the point system. This could motivate users to further increase their point totals so they will see more work activities. Similarly, a user might be notified that his/her skill level of P5 (proficient skill level 5) allowed him/her to see a certain number or percentage of work activities in a particular service area, but that the user was excluded from seeing a certain number or percentage of other work activities because the user's skill level was too low. The user may be given opportunities to complete additional training through the unified workforce platform (e.g., watching some training videos, reading some training materials, etc.) to increase their skill level to receive more work activities. The users may be periodically evaluated for their skill level (e.g., given periodic evaluation tests) to increase their skill level ranking. The notification may give the user instructions or options for how to seek reevaluation of the user's skill level and/or how to complete additional training.

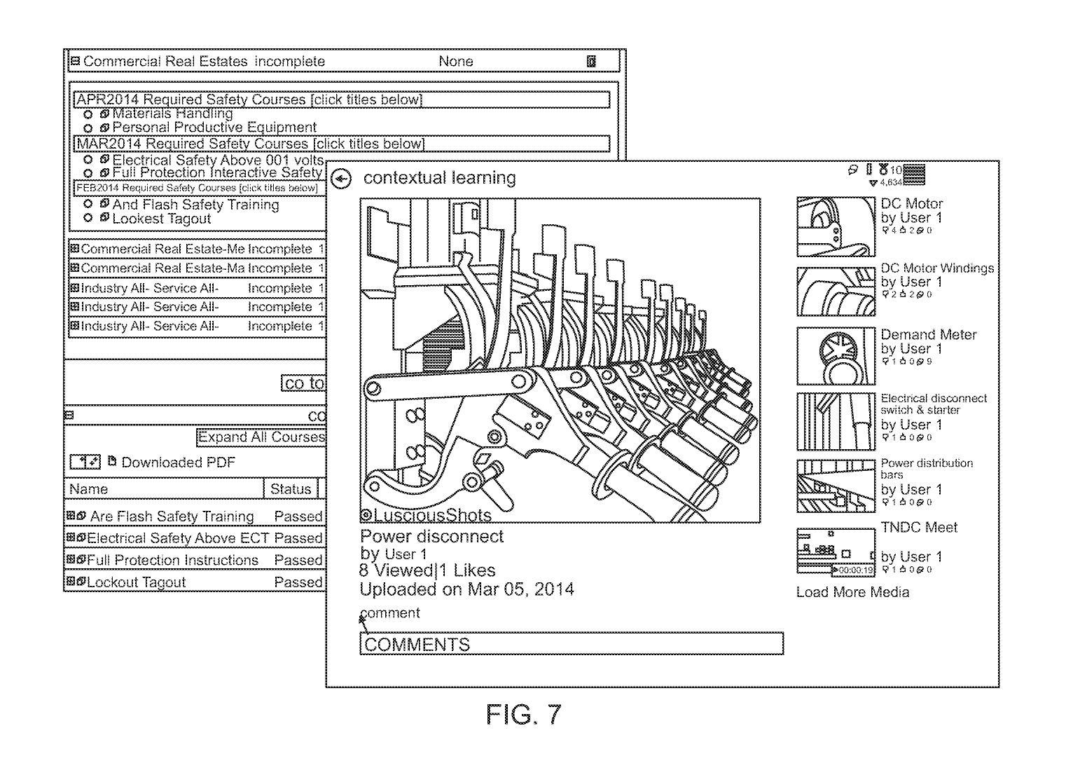

The unified workforce platform may also be used for training and/or learning purposes. For example, the unified workforce platform may provide and/or facilitate formal learning and/or dynamic contextual learning. FIG. 7 shows two pages that may be used for learning. The formal learning page is in the background and lists formal training programs, including safety training programs, general training programs, required training programs, etc. The page may also track and/or show which training programs have been completed, when they were completed, whether a user passed or failed the training, and/or other relevant information. The unified workforce platform may also actively manage, help satisfy, and track continuing education requirements for practicing professionals. The unified workforce platform may maintain user transcripts showing attendance, attempts at courseware, scores, completed curriculum, etc.

A page of the dynamic learning or contextual learning module is in the foreground of FIG. 7. The dynamic learning or contextual learning module provided and facilitated by the unified workforce platform makes practical and ongoing learning much easier and more collaborative. The dynamic learning or contextual learning module may include media (e.g., videos, audio files, and/or pictures), instructions, suggestions, comments, etc. uploaded by various users (e.g., service providers) to the dynamic/contextual learning module. The media, instructions, suggestions, comments, etc. available in the dynamic/contextual learning module may be focused on practical helps for service providers encountering common or rare issues. For example, pictures may be accessed from the dynamic/contextual learning module to help identify equipment or components of equipment relevant to a work activity and/or work site. Similarly, videos may be accessed from the dynamic/contextual learning module that provides service providers with instructions, tips, etc. for repairs and/or services.

Users (e.g., service providers) may contribute (e.g., upload) practical learning content (e.g., videos, pictures, audio files) related to a specific work site, site specific equipment, other relevant equipment, and/or other helpful information. Users may also make comments on the various media, instructions, tips, suggestions, etc. in the dynamic/contextual learning module to help refine the collective knowledge and point out other issues that may arise, and/or ideas/tips for other approaches to a problem. Associating learning content and/or media (e.g., videos, pictures, audio files) to field assets/equipment and/or work sites and providing the ability to discuss asset/equipment specific content and/or site specific contents helps grow a perpetual learning environment, make sure relevant knowledge is not lost, and improve efficiency and effectiveness. For example, if one service provider services a specific piece of equipment at a work site and posts a video about the repair, then a subsequent service provider comes to service the equipment at a later time, the subsequent service provider will have very relevant information to review about the specific equipment and how best to service it. All the learning information and/or media may include location information, other key identification information, and/or other relevant information to help make finding the most relevant information quickly and easily.

Clients or companies requesting services that use the unified workforce platform may also access the dynamic/contextual learning module and may be able to fix or address certain problems or issues on their own based on the knowledge found there, without requiring a service provider to be dispatched to their site. For example, if a service provider services a specific piece of equipment at a work site for a client and posts a video about the repair, and the problem reoccurs at a later time, then the client may be able to view the video and service the equipment themselves. Users and companies may subscribe to receive notifications when new media or other information about their work sites, equipment, and/or other areas of interest is posted.

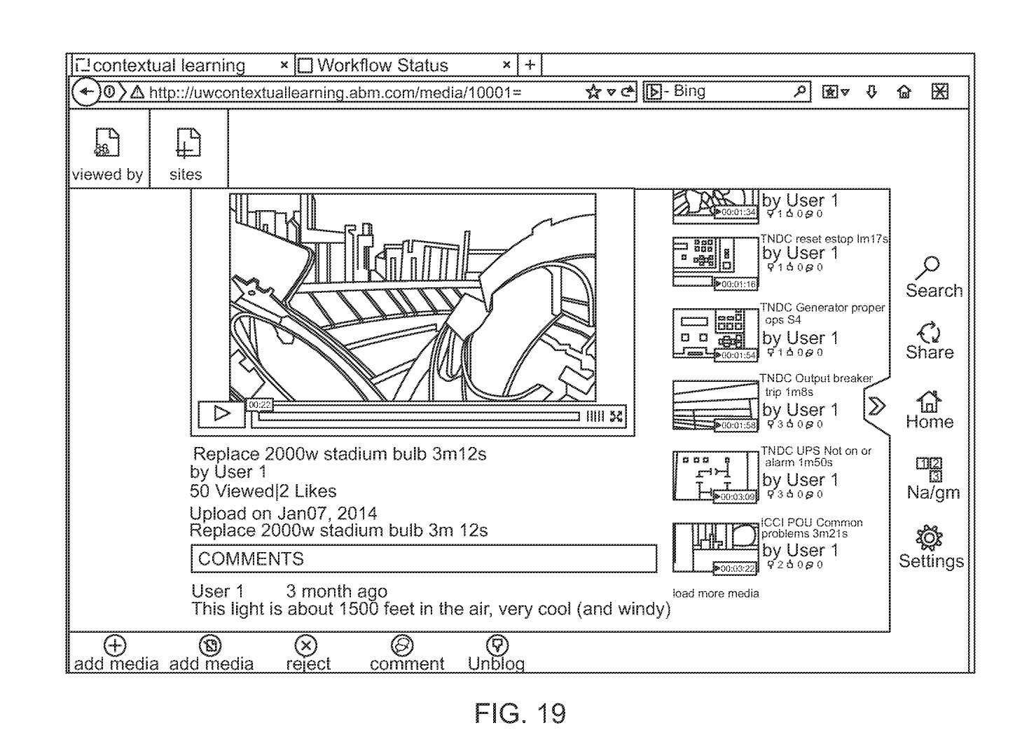

In FIG. 7 a large picture of an old power disconnect is shown. This picture could help service providers identify old power disconnects that they might encounter at an old building. Below the picture is additional information, e.g. a description. The additional information (e.g., description, instructions, tip, etc. associated with the picture may give service providers useful knowledge when dealing with a power disconnect of this type. Below the additional information, other users/service providers may make comments on the picture and provide more useful knowledge and tips on an ongoing basis. Optionally, as shown for example in FIG. 19, a video (e.g., with instructions on how to perform a repair or service) may be accessed and occupy the same location as the large power disconnect picture does in FIG. 7. The right hand side of the dynamic/contextual learning module page may be populated with links to other media, instructions, etc. that a user/service provider might also find interesting, relevant, or related to the work activity. As users/service providers encounter new challenges or issues, they may consult the dynamic/contextual learning module for ideas on how to address the challenges or issues. As challenges or issues are solved, the users/service providers may share their knowledge and describe how they solved the challenges or issues so other users/service providers will know what to do when they encounter the same challenges or issues. Accordingly, dynamic/contextual learning module is dynamic and continues to be updated and refined to address any issues that may arise during work activities. Discrete groups and forums may allow users to engage in issue/innovation discussions and share ideas.

A reveal button, link, jump menu, expansion arrow, toolbox, or similar feature may be included to provide access to tools or “charms” to help navigate and/or otherwise interact with the dynamic/contextual learning module. For example, FIG. 19 shows an exemplary reveal button or expansion arrow that has been clicked to reveal additional tools or “charms” to navigate and interact with the dynamic/contextual learning module. The additional tool or “charms” may include a search utility or engine. While the dynamic/contextual learning module can suggest media, training, instruction, or other information predicted to be of interest to a user, a search utility or engine may also be provided to help the user navigate to the desired contextual learning information. The search utility or engine may be able to search for relevant key words or search terms in the comments, titles, descriptions, content, relevant sites, or any other relevant information to help identify the desired learning tool or media. As shown in FIG. 19, the additional tool or “charms” may also include a share utility (which makes sharing the media with other people easier), a home page link, a settings link (to adjust various settings), a viewed by button or link (which may show which users have viewed the media or other information), a sites button or link (which may show which sites, e.g., work sites, the media or information relates to or allow users to associate the media with new sites), and/or buttons/tools to add media, edit media, reject media (although the ability to reject media may be limited to users with rights to do so, e.g., administrators), comment, like, dislike, etc. Different users may have access to different tools or “charms” depending on their rights, seniority, and/or other factors.

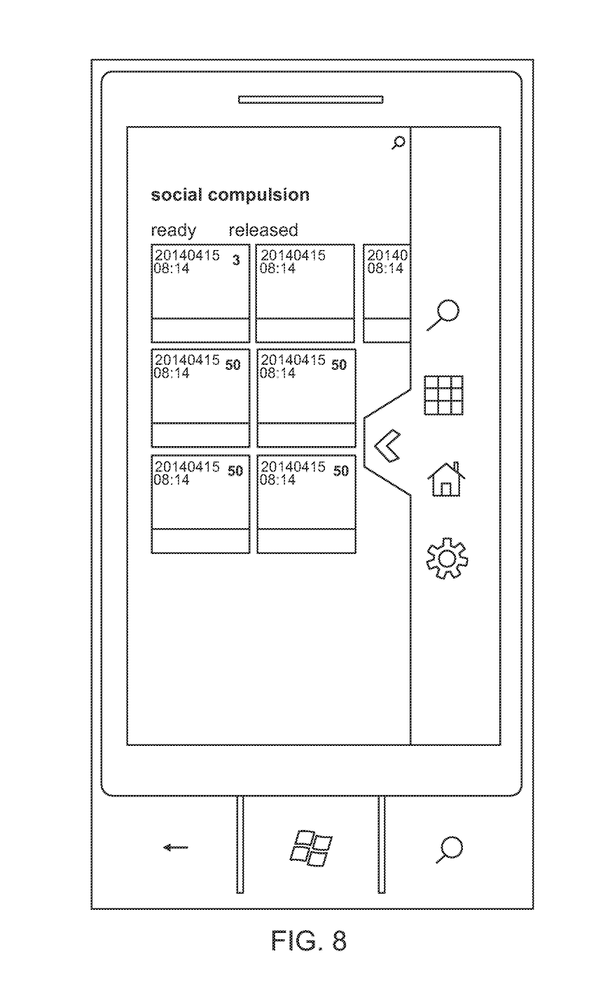

In one embodiment, mobile computing devices (e.g., tablets, phablets, smart phones, etc.) are used to access and contribute to the unified workforce platform. Within a short period of time, mobile screens may be personalized to a client or a particular user, delivering the unified workforce platform interface and tiles that are important to and/or most often used by the client or user. FIG. 8 shows a mobile computing device (i.e., a smart phone) accessing a page of the unified workforce platform. In one embodiment, all the features of the unified workforce platform may be accessed through a mobile computing device.

The unified workforce platform may help users (e.g., service providers, field workers, etc.) complete work activities more effectively and efficiently. This may be especially true when the user may access the unified workforce platform from a mobile computing device in the field. Some exemplary scenarios in which the unified workforce platform may aid a user are described. In one scenario, a service provider/field worker is in the field at a work site and is not sure how to address a problem. The service provider/field worker may use the unified workforce platform to search and locate a fellow service provider/field worker with relevant experience (by skill levels and/or familiarity with the equipment). The service provider/field worker may send a message to the fellow service provider/field worker via the messaging bus and request an immediate perspective. A priority alert may be sent to the fellow service provider/field worker letting him/her know that a fast response is requested. The fellow service provider/field worker may message back ideas for addressing the problem.

In another scenario, a service provider/field worker may not be how to address an unusual service field condition or problem. The service provider/field worker may search within the unified workforce platform dynamic/contextual learning module and locate an image, video, instructions, etc. with related information that may help the service provider/field worker address the unusual field condition or problem. The service provider/field worker may also review the “likes” and comments from fellow service provider/field worker (across all of ABM). In another similar scenario, a service provider/field worker may use the unified workforce platform to bridge out to the community of users and search for related groups or forums discussing the question/problem/issue at hand.

In another scenario, a service provider/field worker receives a scheduled work activity and opens it to see the related equipment. Once viewing the equipment, the service provider/field worker may use the unified workforce platform to bridge automatically to see who the person is with the most experience (e.g., the dynamic subject matter expert) with the related equipment. For example, when a service provider/field worker opens a work activity and interacts with an asset (e.g., equipment at a work site) the service provider/field worker may be tagged with an experience mark. When a work activity is sent to another user for the same and/or similar equipment the user can see all of the previous service providers/field workers that have ever worked on the asset. This allows movement of users across sites which promotes enhanced quality, and provides a direct line to the person with the most experience. The subsequent service provider/field worker working on the equipment may communicate with or message one or more of the other service providers/field workers that have experience with the equipment and/or the most experienced service provider/field worker with the equipment for ideas, pointers, information, etc.

Having users (e.g., service providers) use mobile computing devices may provide additional benefits that may be used by the unified workforce platform. For example, if service providers are connected to the unified workforce platform via a mobile computing device with location services (e.g., GPS), then when the service provider is working, the unified workforce platform can track the service provider's location. Tracking the service provider's position allows the unified workforce platform to track and verify when a service provider arrives at a service location, how long they are at a service location, and similar information. This information may be used by the points engine to add or deduct points. Tracking the service provider's location may also allow the unified workforce platform to predict and update predictions of when a service provider will arrive at a service location. This may allow clients to see when a service provider is headed to the service location and be prepared for the service provider to arrive. It is often a frustration for clients when they do not know where a service provider is or when to expect them, and the unified workforce platform with service providers using mobile computing devices linked to the system may alleviate this concern and allow clients to better plan and predict their day.

Tracking the service provider's location also allows an employer of the service provider to verify the location of the service provider and that the service provider is in an expected location. For example, the location of the mobile computing device from the location services on the device may be compared to the work activity and the service location of the work activity, to confirm the whereabouts of the service provider or discover that the service provider is not at the expected location for the work activity. If a service provider's location is not verified to be in the proper location or the location services on the mobile computing device are turned off, then the unified workforce platform may automatically send an alert or message to the service provider to verify their location or turn on their location services on the mobile device. If the service provider does not respond after one or more attempts to contact them and/or verify their location or does not respond within a certain amount of time, then the dynamic personnel may automatically send an alert or message to the service provider's manager or employer. Location and/or message information may be stored in memory and/or a database.

By tracking location information, the unified workforce platform may provide site or location specific information to users. For example, when a user arrives at a location that includes special instructions from the client, the unified workforce platform may notify the user of those special instructions. For example, if a client has left instructions that service providers always park in back of the complex (not in front), then when the user arrives at the location a message may be sent to remember to part in back of the complex. Also, media relevant to that specific site or location may be messaged or otherwise made available to the user. For example, when the user arrives at the location, a tile, news feed, and/or message may be provided with links to media uploaded from that work site in the past (e.g., if a service provider serviced equipment at the location a year ago and loaded a picture or video, the picture or video may be made readily available to the service provider that just arrived at the location).

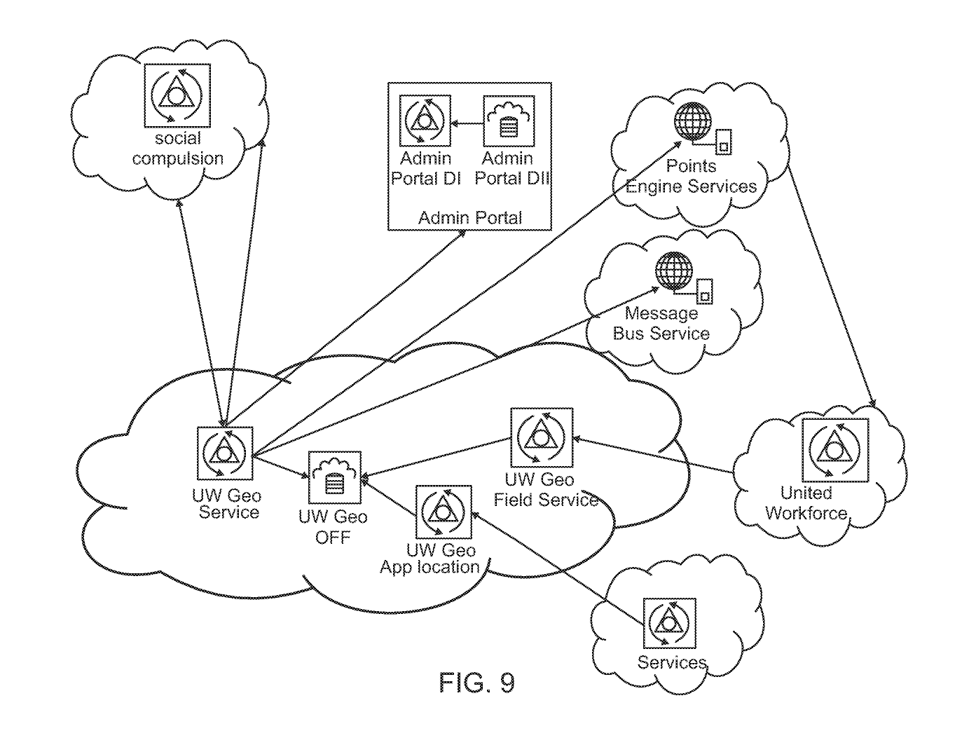

FIG. 9 shows a diagram of features of an exemplary unified workforce platform that may be used in location tracking Many elements of an exemplary unified workforce platform are shown working together in FIG. 9. The unified workforce platform may include and/or use databases, memory, and/or processors. In tracking location of users (e.g., service providers) and influencing behavior of users to go to the correct location, the unified workforce platform may use the points system (e.g., awarding or deducting points based on whether the user goes to the correct work site and how long it takes to get there, etc.), the messaging bus (e.g., to send reminders or warnings), the administrative portal (e.g., to adjust variables), databases to store location and timing information (e.g., if a client requests confirmation that a service provider went to the work site, location tracking information may be retrieved to show the location and/or movement of the service provider), and more.

FIGS. 10 and 11 show exemplary screenshots of pages of the unified workforce platform. FIG. 10 shows a “[client] work activity” page with 8 tiles on the page that may be accessed by a client of the unified workforce platform (e.g., a company requesting services). FIG. 11 shows a “[learn]ing” page with 9 tiles on the page. The “[learn]ing” page may be accessed in more than one way, including by clicking on the “[learn]ing” tile shown in the bottom left corner of the “my role” section of FIG. 16. The tiles in FIGS. 10 and 11 may include a title, e.g., as shown in the darker bar on the bottom of the tiles, that provides a brief description of the information to which the tile provides access. The tiles may also provide a small snapshot of information and may act as a link to additional information. The tiles may be continuously or regularly updated with basic information and/or data feeds, i.e., the text shown on the tiles above the title may be continuously or regularly updated. In this way, relevant information may be provided in one screen view with updates and automated data feeds of learning based content. The large numbers in the upper right corner of the tiles indicates how many notices or information items in each tile have not yet been read by the user. The tiles may be different colors, and the different colors may represent different categories of information, e.g., red may signify “run,” magenta may signify “my stuff,” teal may signify “team” information, etc.

The unified workforce platform may include a variety of tiles with a variety of information. The system may suggest tiles that are likely to be of interest to the user, but users may also be able to customize the interface pages with tiles the user is interested in or believes are relevant to their work. Users may subscribe to receive information of interest or receive notification when new information is posted. Some non-limiting examples of tiles that may be used are shown in FIGS. 10 and 11. For example, the “launch [client]” tile in the upper left corner of the screen in FIG. 10 provides information and/or a link to information regarding the technicians or service providers, e.g., how many service providers are active or not active, where the service providers are located, what work activities the service providers are working on or have in their queue to work on, and other relevant information. The “launch metropolis” tile in the middle of the top row of tiles may allow the client to access information relevant to their industry or interests, e.g., case studies, media added, etc. The “alert” tile below the “launch [client]” tile may provide information on traffic issues that the service providers may encounter, weather issues, disasters, etc. so the client can reset its expectations for when a service provider will arrive. The “launch media” tile in the center of the screen may provide access to the dynamic/contextual learning module and relevant information there. The “activity [field] my” and “metrics [field] my” tile may provide metrics regarding work activities and services that have occurred in the field at work sites. In one or more tiles for a service provider/field worker, allotted time for a work activity versus used time metrics may be displayed. This helps give the user more visibility to the user's performance.

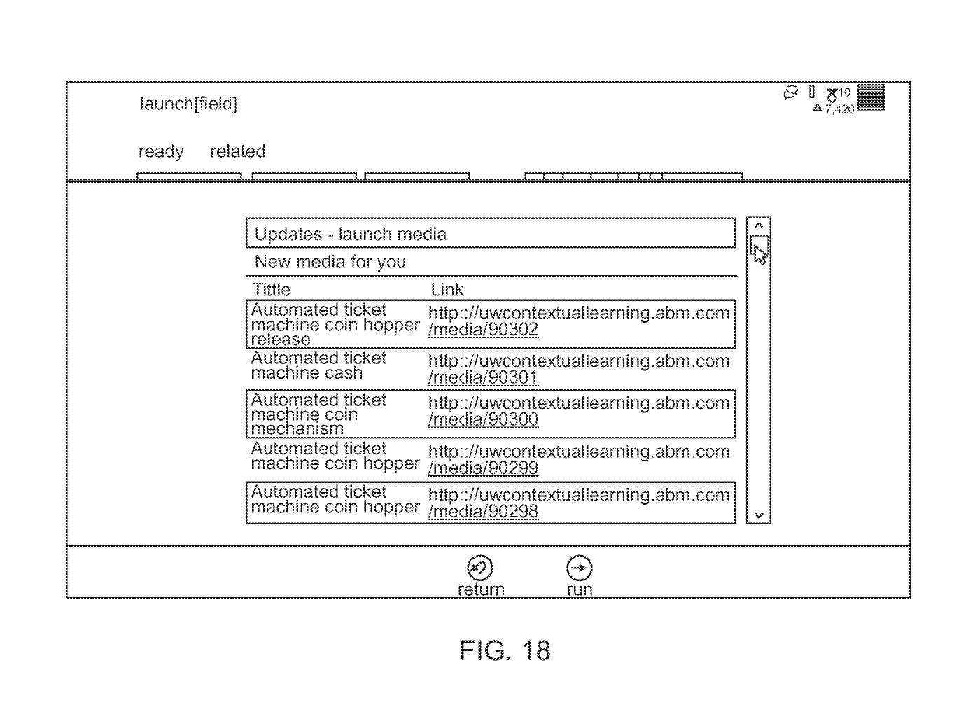

When one of these tiles is clicked or selected, the user may be provided with a list of the new content that the user has not yet viewed. For example, FIG. 18 shows an exemplary screen view after the “launch media” tile has been clicked or selected, and shows a list of new media that the user has not yet reviewed. After viewing this screen, the user may click or select the “run” icon or button shown at the bottom of FIG. 18 to launch the dynamic/contextual learning module.

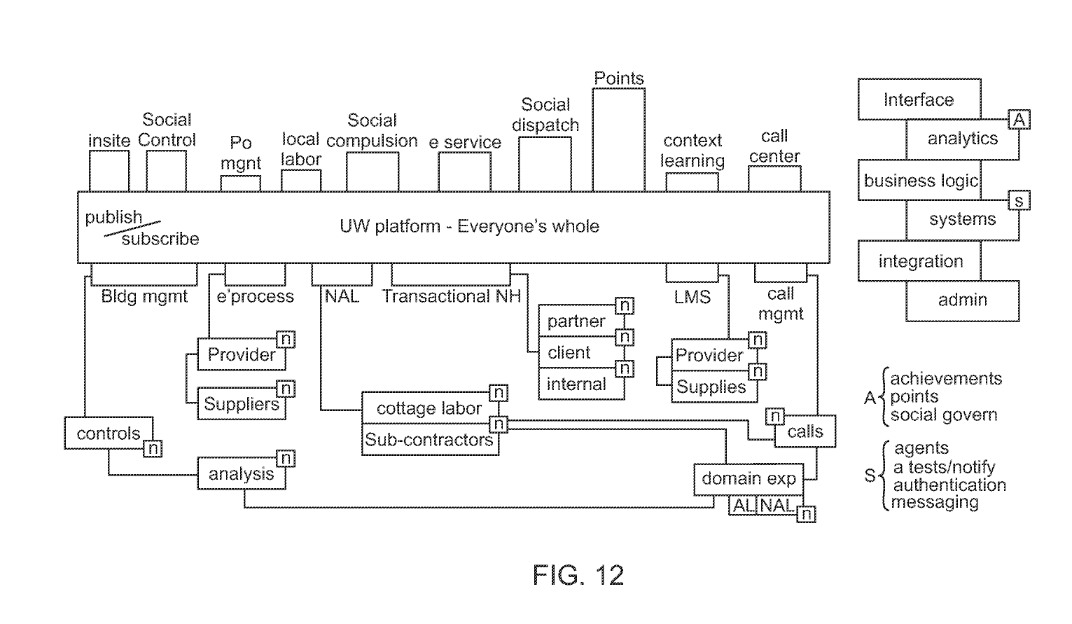

FIG. 12 illustrates how the unified workforce platform may operate as an integration platform. The bar labeled “UW platform—Everyone's whole” represents a service bus with publish—subscribe functionality which can connect to any transactional system with a web service. The top of FIG. 12, above the unified workforce platform service bus, shows components within the unified workforce platform, which gather and display information collected from transactional data or other information shown below the “UW platform—Everyone's whole” bar. The unified workforce platform may provide the information in a clear, organized way and/or may provide analytics about the information collected. If a service provider is at a location working on a work activity and needs a purchase order for a part, the service provider may see a picture of the part, the part number, information about the part, etc. If the client or an individual user wishes to see where other service providers/technicians are to consult, collaborate with, or for other reasons, the client or individual user may access that information. If a service provider needs to access contextual learning about a particular piece of equipment for information to help complete a work activity, the service provider may access contextual learning and information about the piece of equipment. This may all be done by accessing information from transactional systems, preexisting work order systems, procurement systems, building management systems, learning management systems, etc. without having to replace any of those systems.

The unified workforce platform may gather information from the systems without replacing the systems. The unified workforce platform may use the information gathered from other systems to perform the functions/steps described herein. For example, a company/client may have a work order system in which they enter work orders for services that are needed, and the unified workforce platform may subscribe to the company/client's work order system to obtain new work orders and/or other information when entered into the work order system, the unified workforce platform may then create a work activity for the hopper corresponding to the work order from the work order system. The right hand side of FIG. 12 lists components that may be part of the unified workforce platform, including interfaces, analytics, business logic, system, integration, admin, achievement points, alerts, authentication, messaging, etc. The unified workforce platform and the systems from which it gathers information may have a publish/subscribe relationship, e.g., the unified workforce platform receives information from a client system about a work order, then the client system receives information back from the unified workforce platform. While the unified workforce platform need not be a transactional system itself, it can still monitor and gather intelligence from transactional systems and use the information to provide contextual content and decisions for users (e.g., field, office and/or clients). As a result, the unified workforce platform is constantly gathering average times for common “natures of call” assisting in our dispatch and pricing algorithms.

The service bus of the unified workforce platform may be configured to be compatible with a wide variety of client systems, e.g., transactional systems, preexisting work order systems, procurement systems, building management systems, learning management systems, etc. The unified workforce platform may provide an easy way to standardize the information for a wide variety of users. The unified workforce platform may keep all systems data models up to date while providing a common interface for the user (e.g., service provider, field worker, client, and/or office personnel). In one example, a company may have multiple (e.g., 4, 5, 6, etc.) transactional systems that are used in different locations, and users (e.g., service providers) may have to learn to navigate all the different transactional systems to do various jobs for the company. However, the unified workforce platform is compatible with these systems, pulls the relevant data and provides a unified platform that users (e.g., service providers) may use to navigate all the relevant information and complete the jobs. With a unified workforce platform, users no longer need to learn to navigate many different client systems (within a client or from different clients), but may navigate everything through the unified workforce platform. This way a user only needs to learn one system, i.e., the unified workforce platform, to do his/her work, rather than having to learn many different systems used by individual clients and/or multiple different clients.

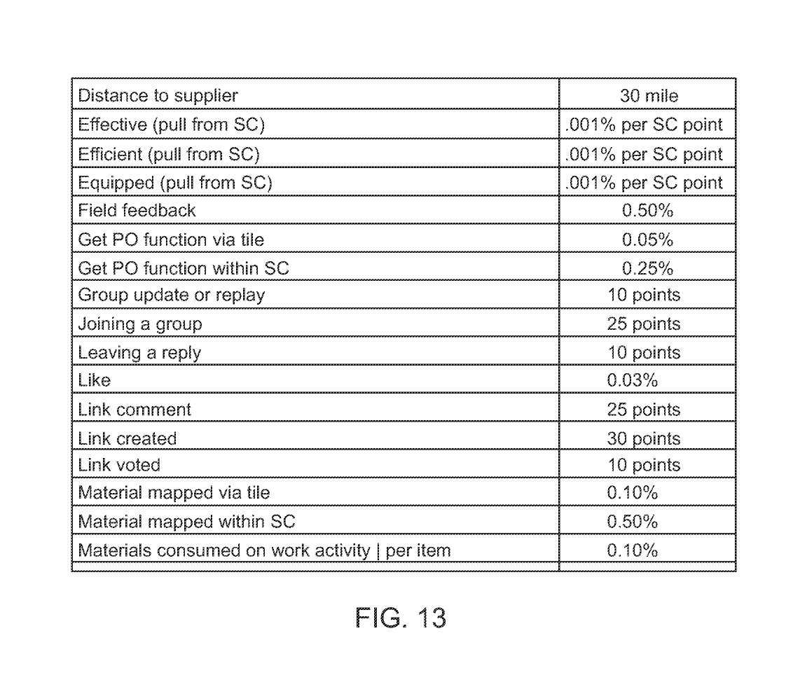

FIG. 13 shows a table of behaviors and other measurements that the points engine may use for calculating point totals for users. For example, posting a group update may earn the user 10 points, joining a group may earn the user 25 points, leaving a reply may earn the user 10 points, creating a link may earn the user 30 points, etc. Points may also be awarded or deducted on a percentage basis, e.g., as a percentage of total points a user has. For example, if a user had 1000 total points and provided field feedback then, based on the chart in FIG. 13, the user would get 5 additional points (i.e., 1000*0.005=5 points). However, if a user had 2000 total points and provided field feedback then, based on the chart in FIG. 13, the user would get 10 additional points (i.e., 2000*0.005=10 points).

In one embodiment, if a service provider needs a part for a repair, the service provider may receive more points for ordering the part from a nearby supplier than from a supplier a long distance away (e.g., more than 30 miles away). This may help encourage time efficiency. In one embodiment, a cost of a part may also be used. For example, a total cost of a resource/part multiplier may be added to client's profile/preferences and via the administrative portal. Based on the median cost of resource from various contractors in the area (dictated by the office distance for substitute parts) points may be awarded or deducted at the activity score depending on if they are above or below the average cost. In another example, the unified workforce platform may calculate distance from the work site and the cost of the part and thereby establish a total cost per mile for the part (e.g., if the closest part is much more expensive than the same part sold further miles away, then the unified workforce platform may decide that the better value is to purchase the cheaper part from a supplier located further away, and the points will reward this decision or the decision that adds the most value).

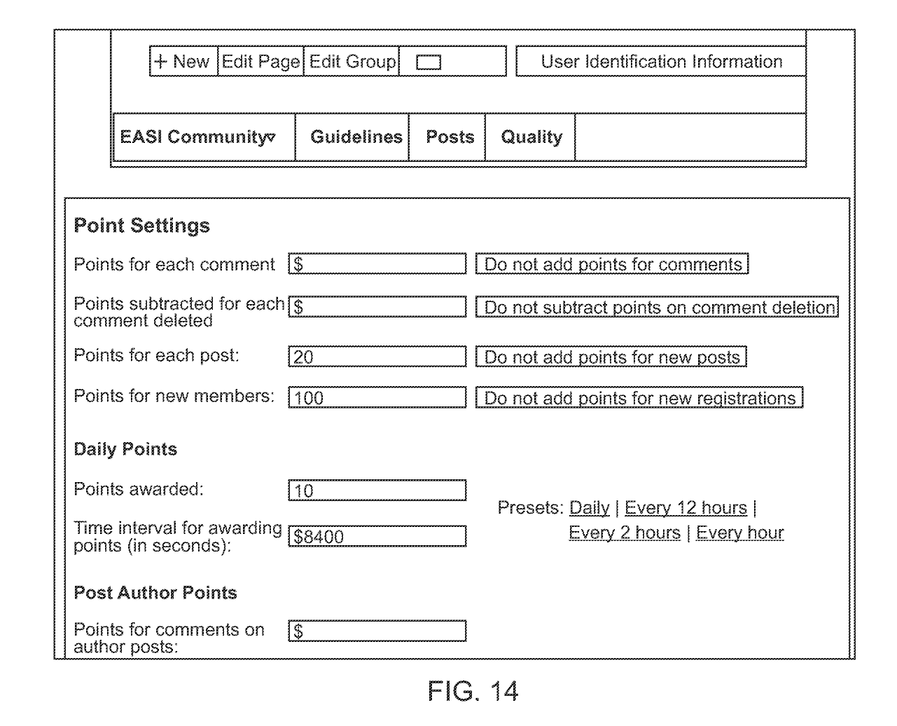

FIG. 14 shows an exemplary page of an exemplary administrative portal on which an administrator may massage or change the amount of points awarded or deducted for various activities. As discussed above, a variety of options are available for massaging or changing the points. Some possible point settings are provided in FIG. 14, including “Points for each comment,” “Points subtracted for each comment deleted,” “Points for each post,” “Points for new members,” and “Points for comments on author posts.” The totals for each of these point setting factors may be changed to award or deduct any number of points. Daily points may also be added for actively using the unified workforce platform each day, and the amount of daily points may be adjusted as well.

FIG. 21 shows another exemplary page of an exemplary administrative portal on which an administrator may massage or change the amount of points awarded or deducted for various activities/behaviors. As discussed above, a variety of options are available for massaging or changing the points. The page in FIG. 21 shows a list of five exemplary behaviors/activities for which points may be awarded or deducted, i.e., media posting, skill increment, media likes, check in, and pick up. In FIG. 21, the “media posting” behavior/activity has been clicked on or otherwise selected, and additional information regarding “media posting” is shown on the bottom half of the page because it has been selected (as other behaviors/activities are selected, the bottom half may change to provide more detailed information about the other behaviors/activities and allow changes to be made). The title or description of the activity and a start time and an end time for awarding points for the activity may be entered. If an end time is selected, then points will no longer be awarded for that activity after the end time; however, one may decide not to enter an end time such that points will continue to be awarded. At the bottom of the page, the amount of points to be awarded for the activity may be changed. In FIG. 21, the points are set to award points in the amount of 0.25% of a user's total points, but the type and amount of points awarded or deducted may be changed.

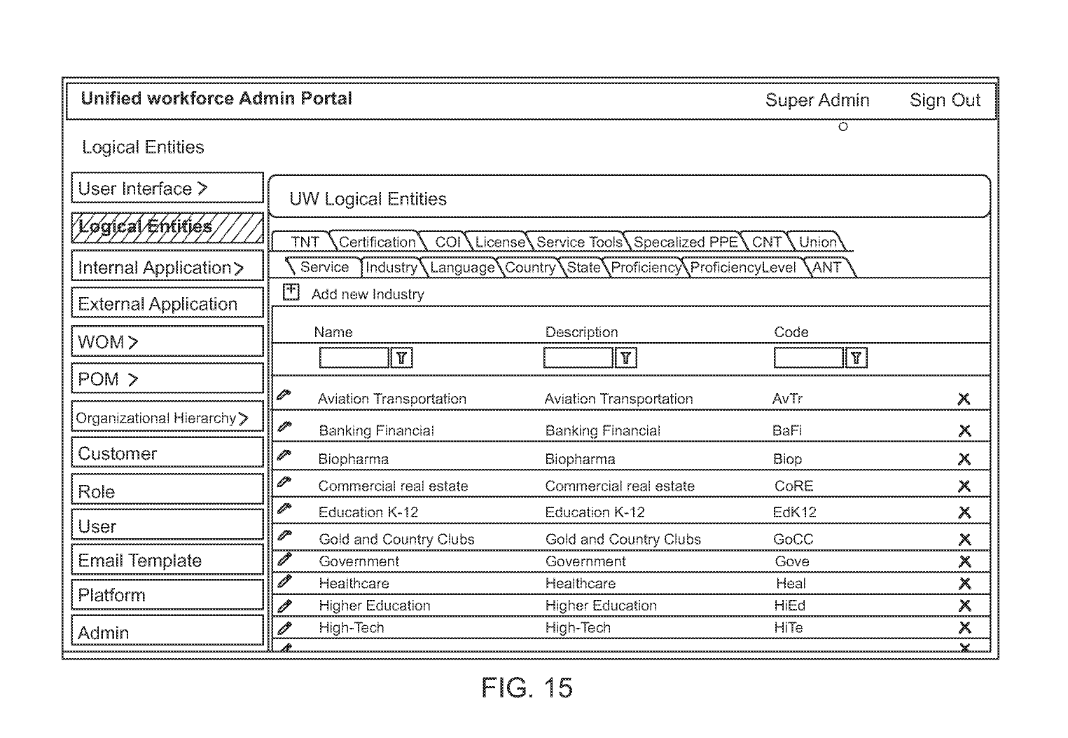

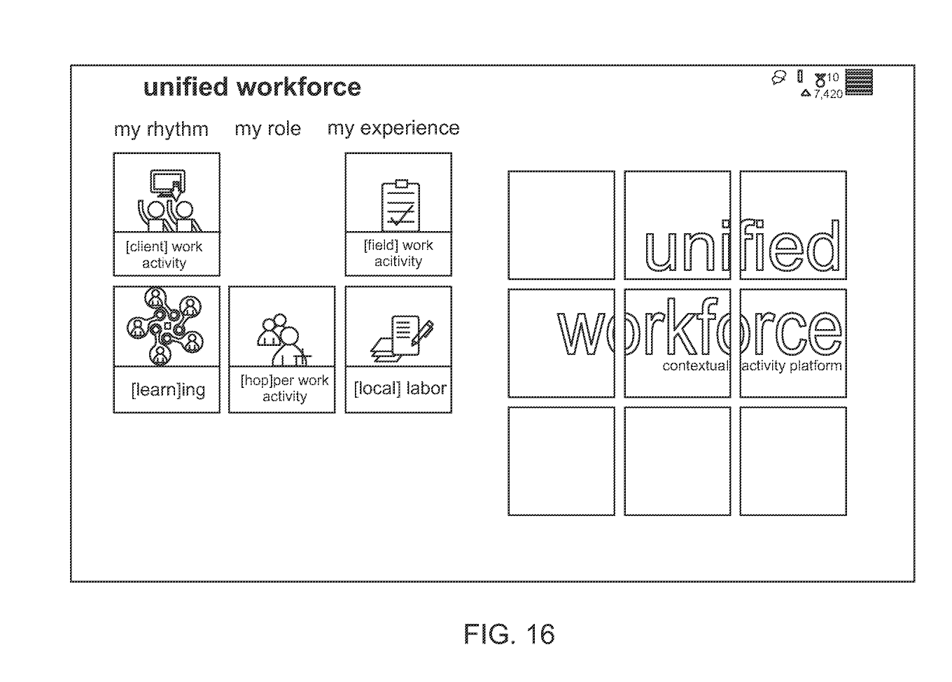

FIG. 15 shows a page of the administrative portal on which an administrator may change a wide variety of variables to customize or tailor the unified workforce platform to the particular needs of the organization or group of organizations to which the administrator belongs. A variety of tabs are provided and each tab includes a variety of options for changing variables and customizing the unified workforce platform.

FIG. 20 shows a diagram of factors that influence the hopper 20 and help it to work properly for efficient and effective work distribution. Many of these factors have been discussed previously herein. FIG. 20 illustrates how many of the factors of the unified workforce platform combine to influence work distribution through the hopper 20. The hopper may include a combination of hardware and software. The hopper may include and/or use memory and one or more processors to store and/or process information and data that influences work distribution. At the center of FIG. 20 is the hopper 20 or “hopper activity.” Factors that influence the hopper activity are show connected to the hopper 20. The primary factors may include the learning management engine, the learning spot, field work activity, profile (admin), Points, and/or Workflow. Each of these may have sub-factors as shown in FIG. 20. For example, the learning management engine may control/process/run skill level assessments (e.g., generation and/or administration of the evaluation tests as discussed above) and skill level rankings. The learning spot may control/process/run the formal learning and/or dynamic contextual learning discussed above.

The field work activity may store/control/process various work activity information. For example, the field work activity may store and associate work activity types with the skill levels necessary to adequately address the work activity type, e.g., with a work activity type normalization table. As new work activities come in, the field work activity engine/module may automatically associate the new work activities with known work activity types and thereby assign an associated skill level required to complete the new work activities. The skill level assigned to a work activity may be different depending of the industry and/or experience of the service provider. For example, a repair call may be more difficult in certain industries. Also, a “too hot” work activity may be assigned an F2 skill level requirement in HVAC (such that a service provider with a skill level of F3 in HVAC may see and/or select the work activity), whereas the same “too hot” work activity may be assigned a skill level requirement of P4 in MRO (such that a service provider who has qualified at a skill level of P5 in MRO may also see the order, even if not listed with HVAC skill). All this skill level mapping for new work activities may be done in the field work activity engine/module. Other processing and/or normalization tables may also be used, for example, to ensure safety requirements for a new work activity are properly applied (e.g., via a clearance normalization table). An asset normalization table may be used to ensure equipment is mapped to the same name to help avoid confusion.

The profile module may include administrative functions and/or requirements for the organization and the individual user. Organizations and individual users may associate their profiles with various information that may be considered by the hopper 20. For example, individual user's profiles may include information regarding their skill level qualifications and training for various service areas and industries. Individual users may also list a preferred drop off or delivery location for parts ordered. Organizations or offices may set certain requirements or criteria (e.g., requirements or criteria 22) to their profile so that service providers meet certain requirements important to the organization. For example, the organization or office may require that service providers must be within a certain geographical proximity to see a work activity from the organization (e.g., to ensure time is not wasted in excessive travel). The organization may prefer internal employees receive the work activities before external labor or service providers, and may customize a preference for internal employees to see work activities first (e.g., the organization may cause the hopper to count points accumulated by internal employees at full value, but discount external labor points by 50% or another percentage, so the external service providers appear to have half as many points to the hopper and receive notifications at a later time).

The points engine/module may function as the points engine described above and influences work distribution through the hopper 20 because notifications of new work activities are distributed based on the point totals of eligible candidates for the work activities. The points engine also facilitates behavior modification by facilitating modification of points awarded or deducted for various activities and/or behaviors, as discussed above.

As discussed in more detail above, the workflow module or activity awareness module may generate periodic activity awareness notifications (e.g., every 30 days) informing individual users of how many work activities they were allowed to see during the period and how many work activities they missed out on seeing and why the users missed out on seeing the work activities. For example, a user might be notified that their skill level of F8 (fundamental skill level 5) allowed them to see 30% of work activities in a particular service area, but that the user was excluded from seeing 70% of other work activities because the user's skill level was too low. The user may be given opportunities to complete additional training and/or take another evaluation test to increase their skill level to receive more work activities. The workflow module may also launch the declared assessments program or page in which the user may declare the industries, service areas, and skill levels, the user believes he/she possesses.

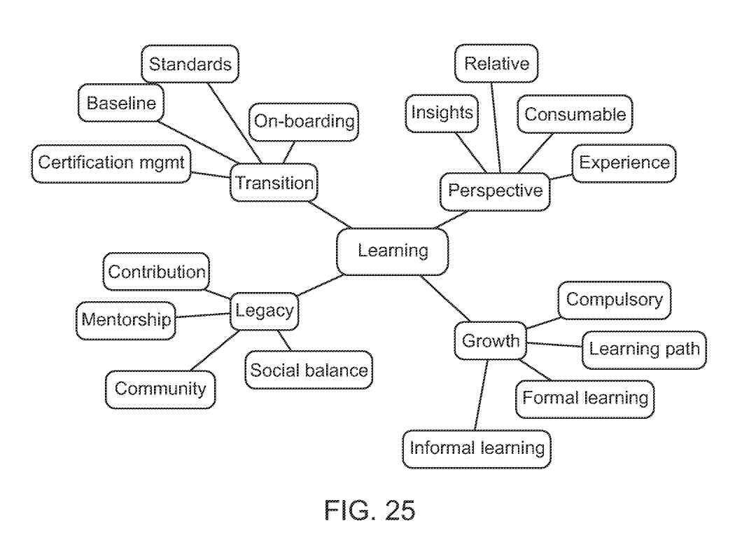

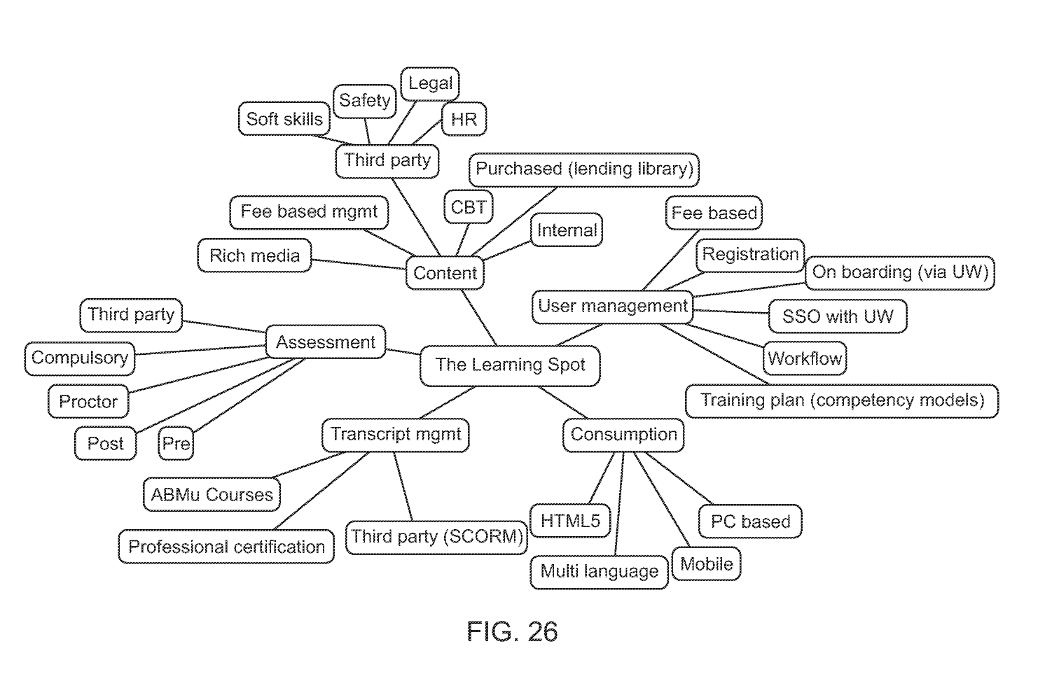

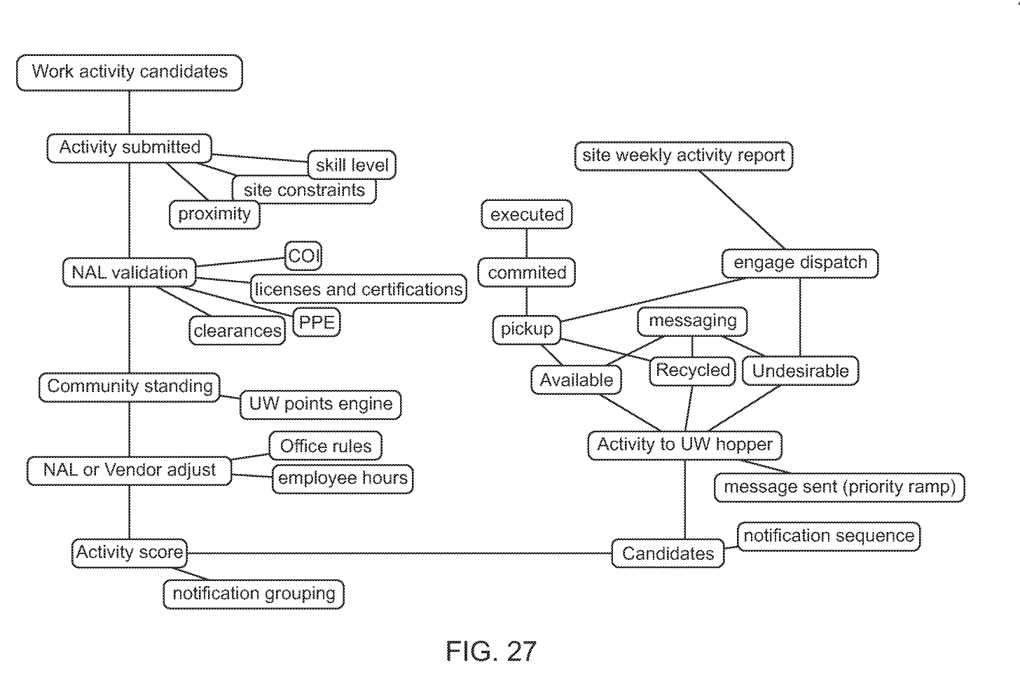

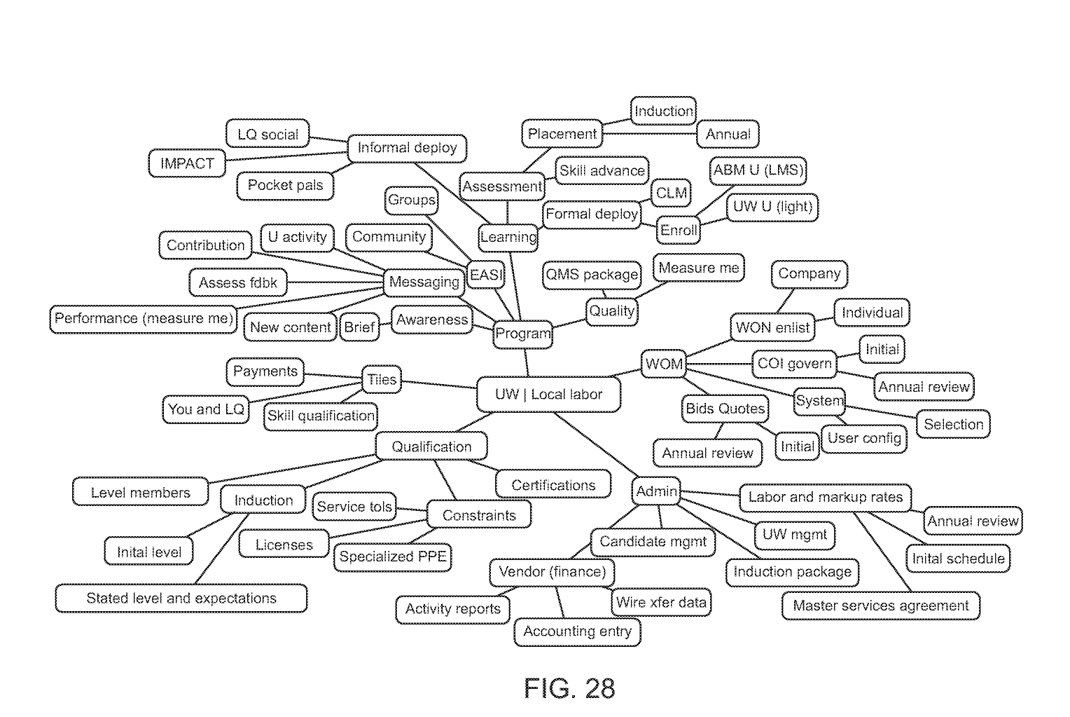

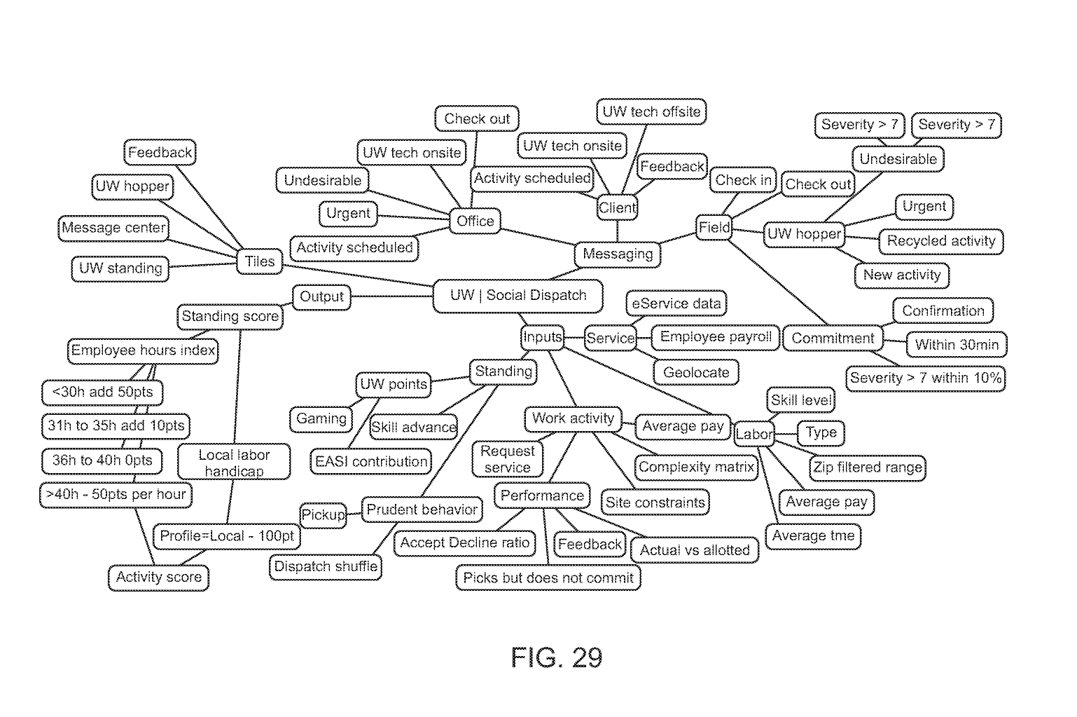

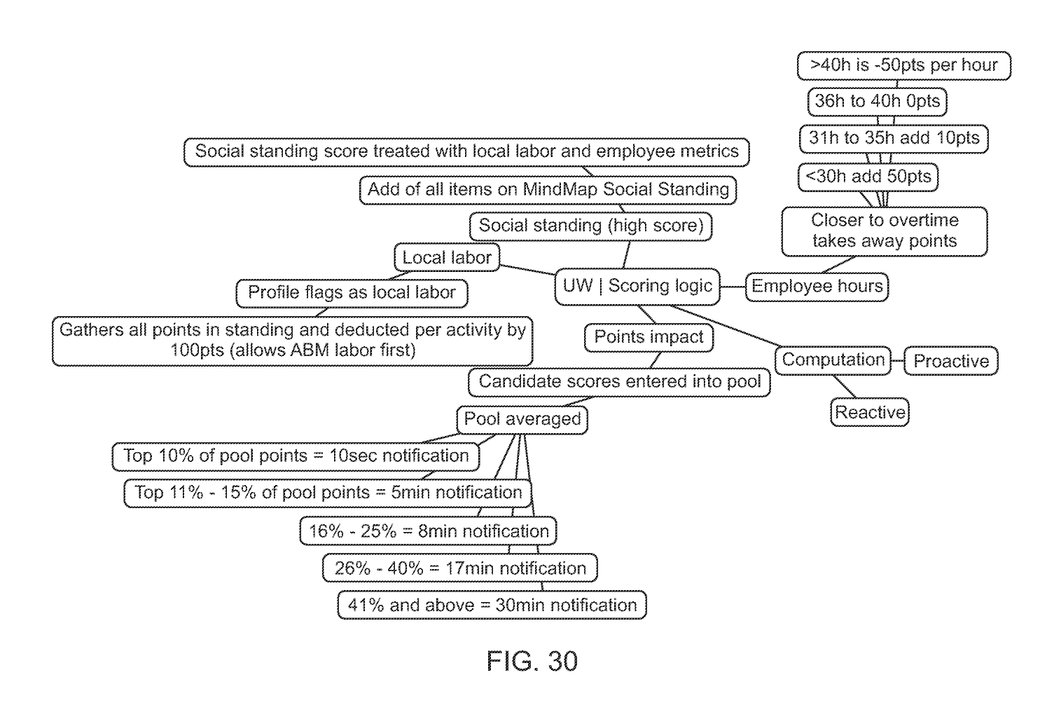

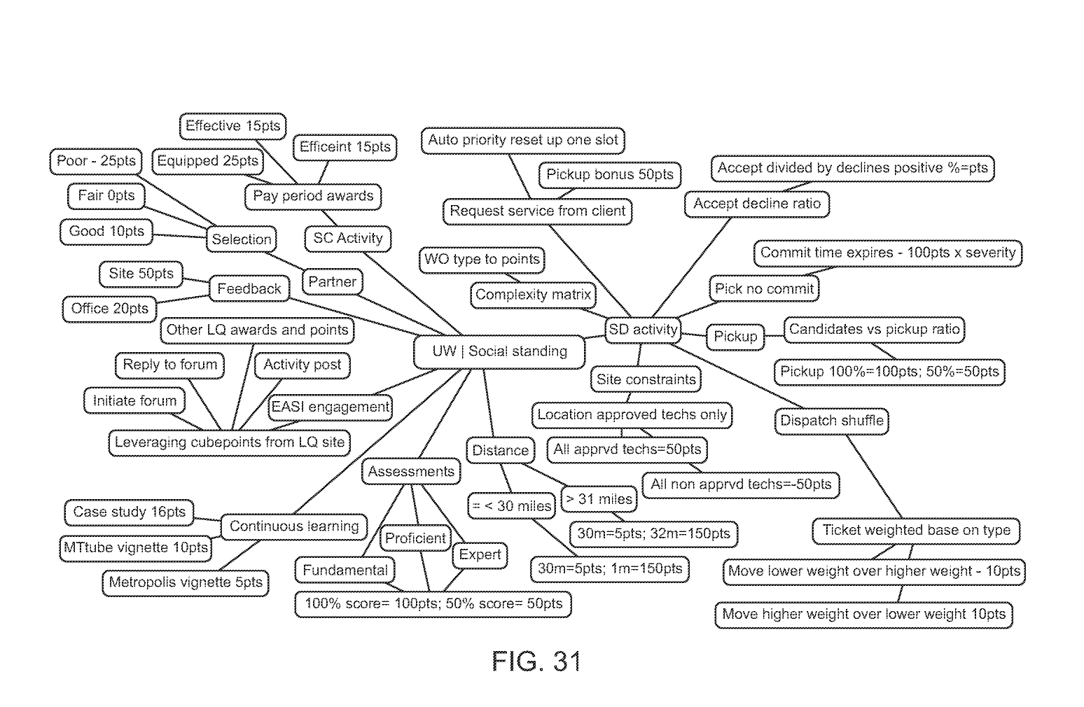

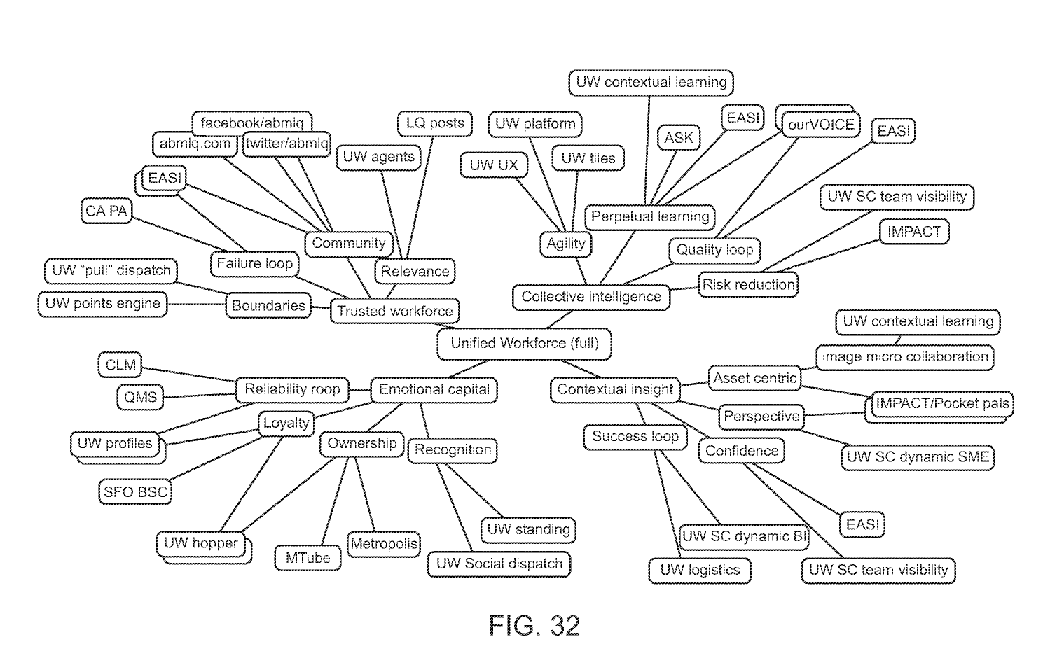

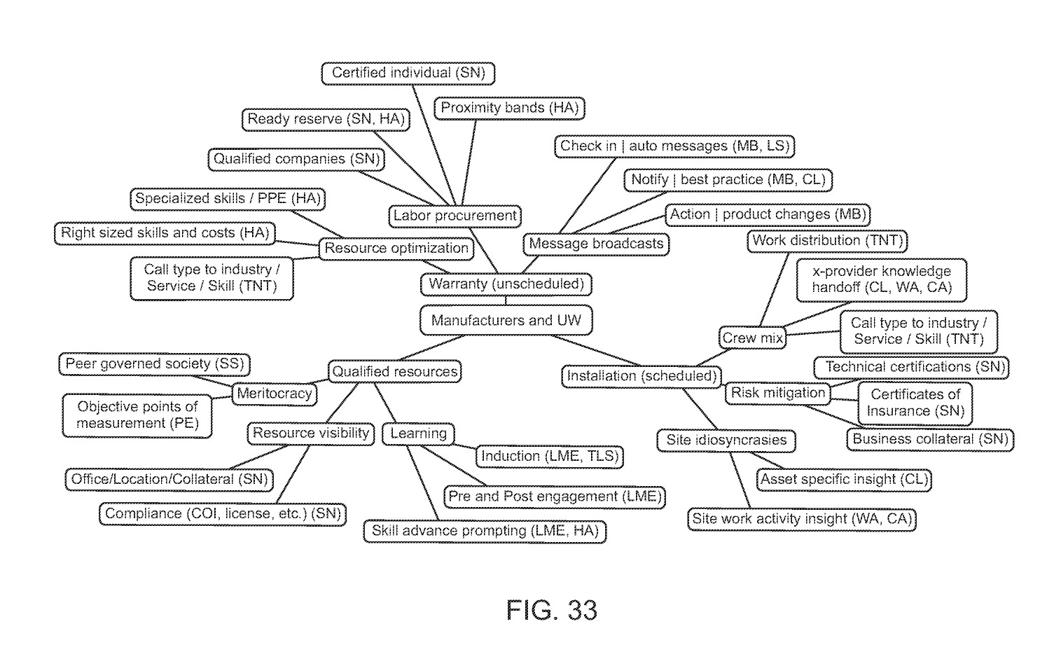

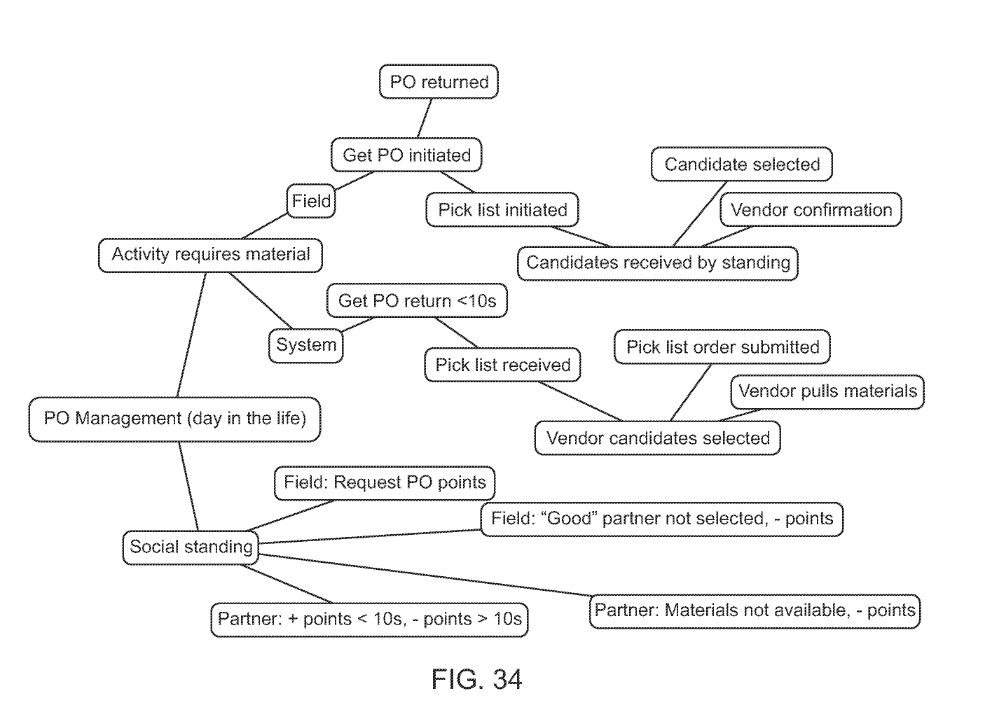

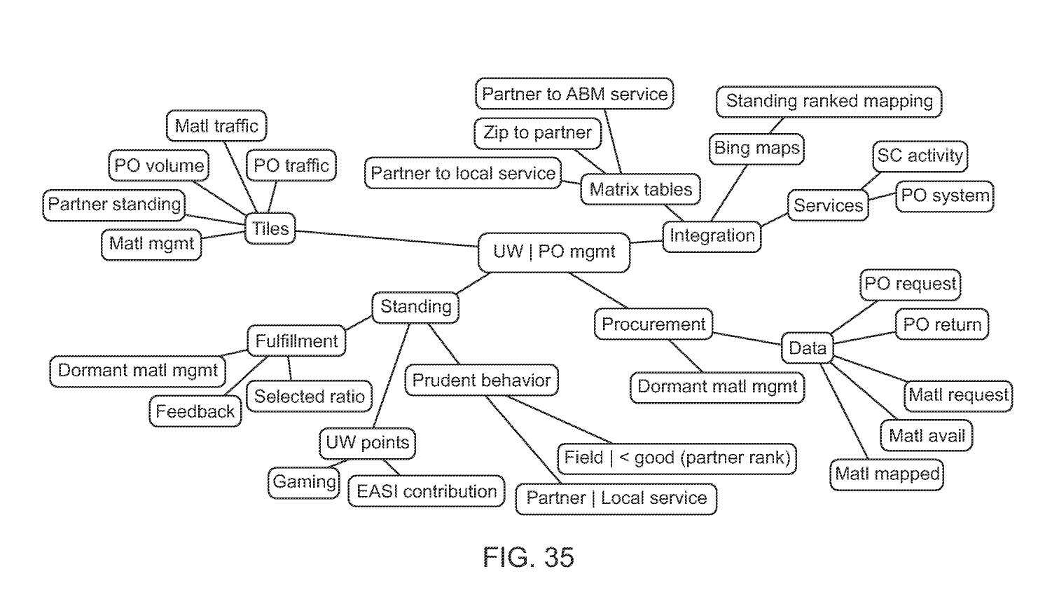

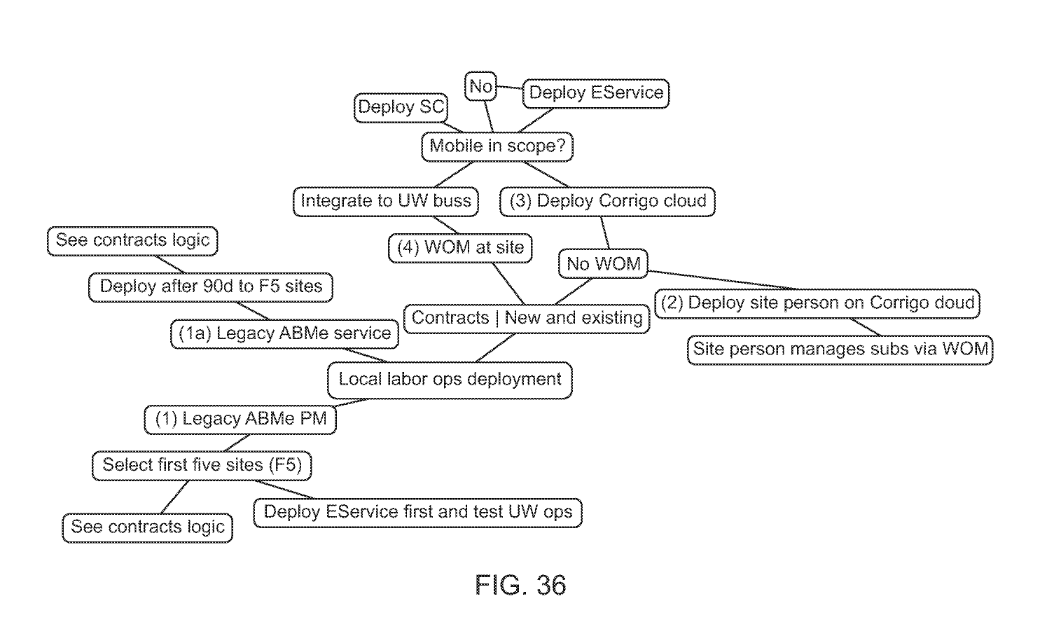

FIGS. 24-36 include diagrams showing exemplary components and/or aspects of an exemplary unified workforce platform. FIG. 24 shows a diagram of exemplary components and/or aspects of an exemplary unified workforce platform titled, in one embodiment, the unified workforce galaxy. FIG. 25 shows a diagram of aspects of an exemplary learning component of an exemplary unified workforce platform. FIG. 26 shows a diagram of aspects of an exemplary learning component of an exemplary unified workforce platform. FIG. 27 shows an exemplary model of how a work activity may be handled in an exemplary unified workforce platform. FIG. 28 shows a diagram of ways local labor may interact with an exemplary unified workforce platform and features of the exemplary unified workforce platform that impact the local labor. FIG. 29 shows a diagram of aspects and/or components of an exemplary hopper of an exemplary unified workforce platform. FIG. 30 shows a diagram of aspects of exemplary scoring or points engine logic of an exemplary unified workforce platform. FIG. 31 shows a diagram of aspects of an exemplary social component of an exemplary unified workforce platform. FIG. 32 shows a diagram of aspects and/or components of an exemplary an exemplary unified workforce platform. FIG. 33 shows a diagram of ways manufacturers may interact with an exemplary unified workforce platform and features of the exemplary unified workforce platform that impact the manufacturers. FIG. 34 shows a diagram of aspects of an exemplary social component of an exemplary unified workforce platform. FIG. 35 shows an exemplary model for purchase order management. FIG. 36 shows a diagram of factors and/or components of an exemplary unified workforce platform related to purchase order management.

The unified workforce platforms disclosed herein may charge organizations, users, and/or clients in various ways. For example, the unified workforce platform may bill organizations, users, and/or clients on a utility-type licensing model, e.g., similar to a home utility: pay for what you consume (or pay per transaction). Optionally, organizations, users, and/or clients may be charged a subscription fee to use the platform and services. Optionally, organizations, users, and/or clients may be charged on a per office, per building, or per client basis.

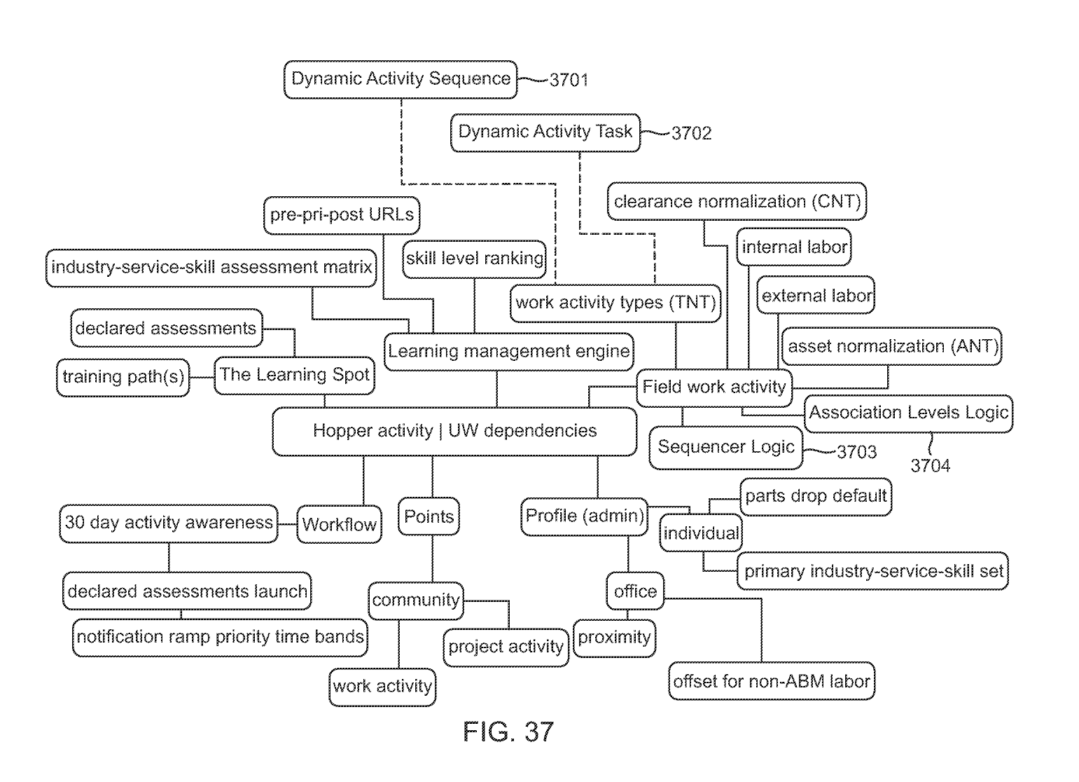

Referring now to FIG. 37, a second diagram of factors that influence an exemplary hopper of an exemplary unified workforce platform is shown. The “field work activity” component of the “Hopper activity UW dependencies” as illustrated in FIG. 20 is shown to incorporate two additional sub-components: (i) a sequencer logic 3703, and (ii) an association levels logic 3704. Additionally, the “work activity types (TNT)” is shown to include two additional types: (a) dynamic activity sequence 3701, and (b) dynamic activity task 3702.

The sequencer logic 3703 is activated when a signal to generate a work order wherein the resulting work activity qualifies as a dynamic activity sequence 3701 is received by the unified workforce platform. In one embodiment, the signal to generate a work order may be transmitted by a sensor in the field, as will be discussed below. In a second embodiment, the signal may be a result of a work originator providing input into the unified workforce platform. A work activity may qualify as a dynamic activity sequence 3701 based on the nature of the call (NOC) of the work activity and/or specific input by the work originator. Herein, the nature of the call (NOC) should be construed as the type of action associated with the work activity. For example, a “field assessment” NOC may signify that the work activity requires a service provider to provide an in-person visit. Herein, a work activity should be interpreted as a standard format provided to one or more service providers detailing a request by a customer, consumer, medical patient, etc.

In one embodiment, a work activity having a specified nature of call will trigger the field work activity component of the unified workforce platform to activate the sequencer logic 3703. For example, a patient of in-home nursing care may input into the unified workforce (UW) platform a request for a nurse visitation to assess the patient's breathing troubles wherein the request results in a work activity having a NOC of “field assessment.” In this example, the UW platform may be configured to automatically initiate the sequencer logic 3703 when a work activity having the “field assessment” NOC is generated (i.e., a “field assessment” NOC is preconfigured as a dynamic activity sequence 3701). In another example, the patient (i.e., or other person who inputs data to the UW platform as a request to generate a work activity) may specifically request the sequencer logic 3703 generate a sequence of events for one or more service providers to follow. In yet another embodiment, the sequencer logic 3703 may be initiated for every ‘x’ work activity (i.e., ‘x’ is a predetermined integer, for example, the sequencer may be initiated for every 4 work activities generated when ‘x’ is equal to 4).

Once the sequencer logic 3703 has been initiated by the unified workforce platform, the sequencer logic 3703 defines a sequence of events for executing the work activity corresponding to the NOC of the work activity. Returning to the example above, the “field assessment” NOC is associated with a predetermined sequence of events, wherein the predetermined sequence of events is stored on a non-transitory computer-readable storage medium accessible by the unified workforce platform components and sub-components. Therefore, as an example, the “field assessment” NOC may have a predetermined sequence of events that may include: (i) an in-home visitation by a first nurse to provide an assessment of the patient, (ii) a review by a second nurse of the assessment data (e.g., measurements taken and observed characteristics recorded by the first nurse), (iii) a treatment plan generated by the second nurse, (iii) a review of the treatment plan by a third nurse, (iv) a filling of prescriptions by a pharmacist, optional according to treatment plan, and (v) execution of the treatment plan by the first nurse. The sequencer logic 3703 may pull the sequence of the work activity comprising the above listed five events from the non-transitory computer-readable storage medium and adjust the events according to the information provided by the patient (or the work originator). For example, the sequencer logic 3703 may select one of a plurality of sequences of events that all correspond to the “field assessment” NOC. In one embodiment, the sequence of events for a “field assessment” NOC regarding breathing troubles may differ from the sequence of events for a field assessment regarding a patient that fell or sustainable a physical injury. Therefore, the sequencer logic 3703 may analyze the information provided by the work originator to determine the corresponding sequence of events. In other words, the sequencer logic 3703 may analyze characteristics of the data received by the UW platform to select a sequence of events corresponding to the NOC of the generated work activity and characteristics of the particular work activity.

Once a sequence of events has been generated by the sequencer logic 3703, a hopper logic 20 generates a notification ramp, as discussed above, for the first event in the sequence of events. In one embodiment, a first event in the sequence of events may have a first NOC and a second event in the sequence of events may have a second NOC, wherein the first NOC differs from the second NOC (although the first NOC may be the same as the second NOC). Therefore, when the first NOC differs from the second NOC, a first notification ramp for the first event may differ from the second notification ramp for the second event. When the service provider that accepted the first event (e.g., returning to the example above, the first nurse completed an in-home visit to a patient), the patient and/or the service provider may notify the UW platform that the first event was completed. Upon receipt of a notification that the first event was completed, the hopper logic 20 generates a second notification ramp for the second event in the sequence and notifies the appropriate service provider(s) of the second event. The service provider completing each event notifies the UW platform and the hopper logic 20 generates a notification ramp for each event in the sequence of events and notifies the appropriate service provider(s) until each event in the sequence of events has been completed, signifying the work activity has been completed. Herein, when a work activity qualifies as a dynamic activity sequence, the work activity comprises the one or more events that comprise the sequence of events selected by the sequencer logic 3703.

Additionally, the association levels logic 3704 is activated when a signal to generate a work order wherein the resulting work activity qualifies as a dynamic activity task 3702 is received by the unified workforce platform. As with a dynamic activity sequence 3701, discussed above, in one embodiment, the signal to generate a work order may be transmitted by a sensor in the field. Similarly, in a second embodiment, the signal may be a result of a work originator providing input into the unified workforce platform. A work activity may qualify as a dynamic activity task 3703 based on the NOC of the work activity and/or specific input by the work originator.

In one embodiment, a work activity having a specified NOC will trigger the field work activity component of the UW platform to activate the sequencer logic 3703. For example, a patient of in-home nursing care may input into the UW platform a request for help wherein the request results in a work activity having a NOC of “field assessment.” In this example, the UW platform may be configured to automatically initiate the association levels logic 3704 when a work activity having the “field assessment” NOC is generated (i.e., a “field assessment” NOC is preconfigured as a dynamic activity task 3702). In another example, the patient (i.e., or other person who inputs data to the UW platform as a request to generate a work activity) may specifically request the association levels logic 3704 generate a task list for one or more service providers to follow. A task list is a list of predetermined actions a service provider is to complete in order to complete a work activity (or event within a work activity sequence when the work activity is both a dynamic activity task 3702 and a dynamic activity sequence 3701). Herein, a work activity may be both a dynamic activity sequence 3701 and a dynamic activity task 3702.

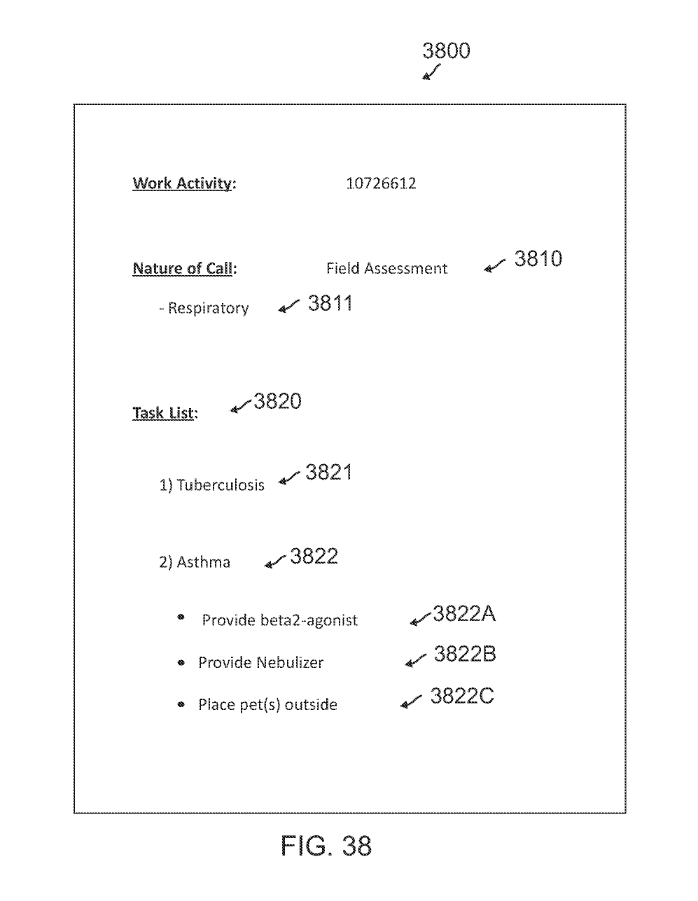

Additionally, a task list may include multiple levels. Referring to FIG. 38, an exemplary work activity 3800 that qualifies as a dynamic activity task 3702 is shown. As illustrated, the “Nature of Call” 3810 is listed as “Field Assessment.” Additionally, the Nature of Call 3810 is associated with a respiratory complication (“Respiratory” 3811). Herein, the association with a specific complication or problem may be determined based on the signal characteristics, as discussed above. Additionally, the task list 3820 includes two first-level tasks (“Asthma” 3821 and “Tuberculosis” 3822) and a plurality of second-level tasks associated with the first-level task, “Asthma” (“Provide beta2-agonist,” 3822A “Provide Nebulizer,” 3822B and “Place pet(s) outside” 3822C). The work activity 3800 may be generated by the association levels logic 3704 by analyzing the characteristics of the signal instructing the UW platform to generate a work activity and extracting information such as the NOC and specific details (e.g., selection of medical issue from a drop down list on a graphical user interface (GUI)). The extracted information may be used by the association levels logic 3704 to query a database and obtain the information to be placed in the task list corresponding to the NOC and any specific details provided. Furthermore, although discussed in terms of responding to a medical complication, a dynamic activity task 3704 may be used for other embodiments, such as responding to a water pipe that burst reported by staff within a corporate building and/or responding to a signal from one or more sensors that the temperature of a freezer within a butchery is rising too quickly.

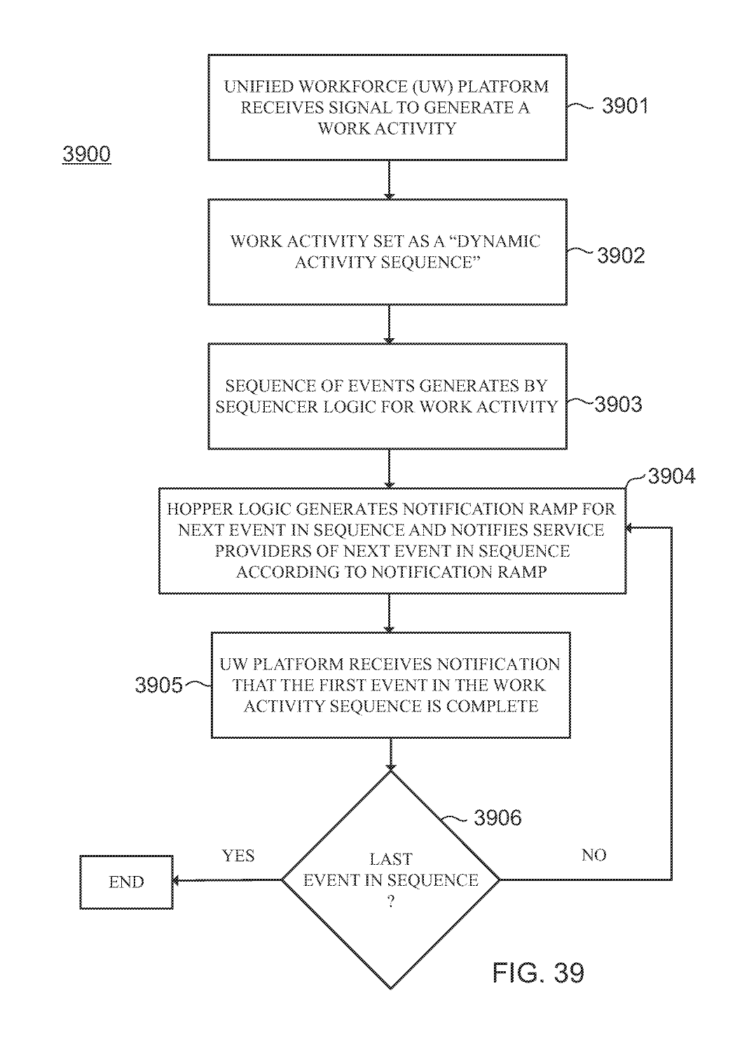

Referring to FIG. 39, a flowchart illustrating an exemplary method for generating and completing a sequence of events for a work activity is shown. Each block illustrated in FIG. 39 represents an operation performed in the method 3900 of generating a work activity and a sequence of events, and ensuring completion of each event in the sequence of events. At block 3901, a unified workforce (UW) platform receives a signal to generate a work activity. A signal received by the UW platform instructing the UW platform to generate a work activity may include, but is not limited or restricted to, (i) the NOC, (ii) additional comments or information including a problem that needs to be addressed, (iii) the time the request was transmitted to the UW platform, (iv) patient information (if applicable), which may include one or more of, inter alia, birthday, sex, blood type, past medical procedures, current medical conditions and/or social security number, (v) the location where assistance may be needed (e.g., global positioning system (GPS) coordinates, or address), and/or (vi) contact information of a responsible party (e.g., a patient, a family member, an owner of equipment that may need to be repaired, or janitorial staff of a company). In one embodiment, a patient may be preregistered with the UW platform (e.g., a patient who routinely has in-home visits from a nurse) such that the patient information may be pulled from a secure database using a unique identification, such as a social security number.

Additionally, the signal instructing the UW platform to generate a work activity may be received via input from a user (e.g., a “work originator”) or from one or more sensors. Input from a user may be a result of input entered into a GUI using input forms such as one or more of, inter alia, a text box, a drop-down menu, a date picker, a radio button, etc. Alternatively, a user may call a telephone number, record a message that is subsequently transcribed into a request using voice recognition software (wherein the voice message is transformed into a standard format specific to the UW platform, e.g., a data structure containing the information of a signal included above). A signal instructing the UW platform to generate a work activity may also be transmitted by one or more sensors (e.g., microelectromechanical system (MEMS) sensors). Herein, one or more of the sensors may be paired with a circuit such as an integrated circuit or an application-specific integrated circuit (ASIC). As will be discussed in detail below, the one or more sensors may be part of an Internet of Things (IoT) system. In one embodiment, a signal from one sensor may trigger the generation of a work activity. In a second embodiment, two or more signals may need to be received (e.g., all within a predetermined time of each other) in order to trigger the generation of a work activity.

At block 3902, the UW platform determines the work activity qualifies as a “dynamic activity sequence.” As discussed above, the sequencer logic 3703 may be initiated by the UW platform (e.g., the work activity qualifies as a “dynamic activity sequence”) when, inter alia, (i) the NOC of the work activity is one of a predetermined type (e.g., a NOC of “field assessment”), (ii) the work originator requests a sequence be generated for the work activity (or request included in the signal from sensor(s)), or (iii) the work activity is an “x^{th}” work activity, wherein the sequencer logic 3703 is automatically initiated by the UW platform every ‘x’ work activities generated.

At block 3903, a sequencer logic 3703 generates a sequence of events for the work activity. Herein, the sequence of events corresponding to the work activity may be a result of the NOC of the work activity. For example, each NOC may correspond to a predetermined sequence of events such that the sequencer logic 3703 queries a database for an entry corresponding to the NOC received within the signal instructing a work activity to be generated. Additionally, in some embodiments, multiple sequences of events may correspond to a single NOC. In such an embodiment, the characteristics of the signal (e.g., information included in the signal) may be analyzed to determine the appropriate sequence of events. For example, a signal requesting the generating of a work activity may include a “field assessment” NOC and information that a patient fell down a flight of stairs. Herein, the sequence of events for addressing the needs of a patient who fell down a flight of stairs may differ from the sequence of events for addressing the needs of a patient who is feeling ill, or from a pipe that burst in a corporate office. The use of the signal characteristics may enable the UW platform to determine the necessary or appropriate sequence of events to a higher level of granularity than if only the NOC is used.

At block 3904, a hopper logic 20 generates a first notification ramp for the first event in the sequence. As briefly discussed above, a notification ramp is a schedule for placing service providers according to a particular order in which they are to be notified of the first event in the sequence. In some embodiments, only a single service provider may be notified at one time. Alternatively, two or more service providers may be notified concurrently (at least partially overlapping in time). For example, FIG. 6 illustrates how a service provider's points total may influence when the service is notified of an event. In such an embodiment, the service providers may be placed in order according to the points total for each service provider (e.g., in a decrementing manner such that the service provider having the highest points total is the first to be notified, or alternatively, in an incrementing manner such that the service provider having the lowest points total is the first to be notified). In one embodiment when two or more service providers are to be notified concurrently, the plurality of service providers to be notified may be determined according to predetermined thresholds such that, for example, all service providers having a points total above a first predetermined are notified first, all service providers having a points total above a second predetermined threshold but below the first predetermined threshold are notified second, etc.

Additionally, the hopper logic 20 notifies one or more service providers the of the first event according to the notification ramp. As discussed above, the notification ramp provides an order for notifying one or more service providers of an available work activity—herein, a first event of a work activity. The notification may be transmitted to one or more service providers, as discussed above,

At block 3905, the UW platform receives a notification that the first (e.g., current) event in the work activity sequence is complete. Subsequent to receiving a notification the current event is complete, the UW platform makes a determination as to whether the current event is the last event in the work activity sequence (block 3906). When the current event is the last event in the sequence (yes at block 3906), the method 3900 is complete as each event in the sequence has been performed. When the current event is not the last event in the sequence (no at block 3906), the method 3900 returns to block 3904 so that the hopper logic 20 may generate the notification ramp for the next event in the sequence.

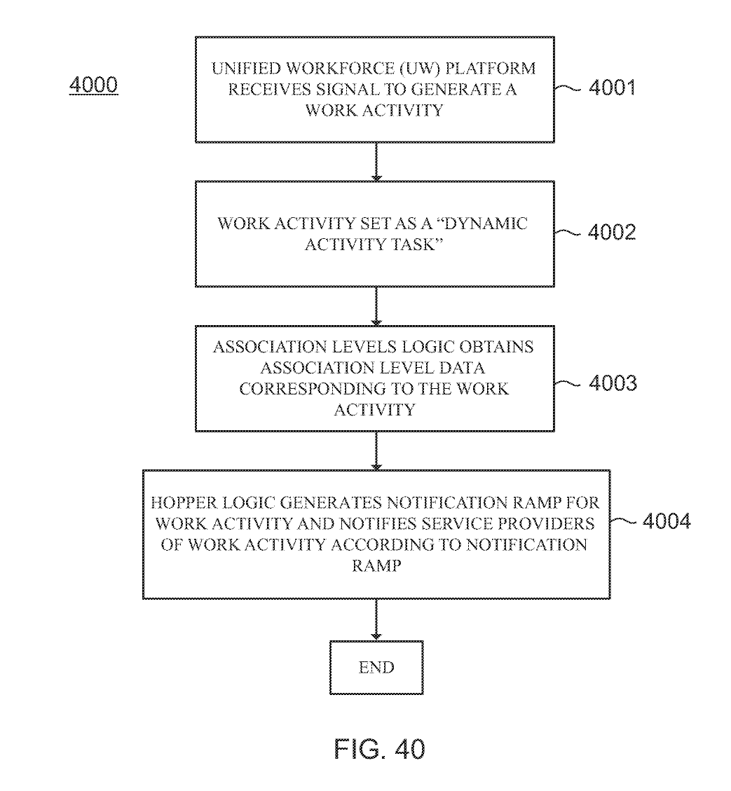

Referring to FIG. 40 in combination with FIG. 38, a flowchart illustrating an exemplary method for generating a work activity that qualifies as a dynamic activity task is shown. Each block illustrated in FIG. 40 represents an operation performed in the method 4000 of generating a work activity that qualifies as a dynamic activity task. At block 4001, a UW platform receives a signal to generate a work activity and generates a work activity based on the data received within the signal, as discussed above.

At block 4002, the UW platform determines the work activity qualifies as a “dynamic activity task.” Similar to the initiation of the sequencer logic 3703 as discussed above, the association levels logic 3704 may be initiated by the UW platform (e.g., the work activity qualifies as a “dynamic activity task”) when, inter alia, (i) the NOC of the work activity is one of a predetermined type (e.g., a NOC of “field assessment”), (ii) the work originator requests a task list be generated for the work activity (or request included in the signal from sensor(s)), or (iii) the work activity is a multiple of ‘x’, wherein the sequencer logic 3703 is automatically initiated by the UW platform every ‘x’ work activities generated.

At block 4003, the association levels logic 3704 queries a database for association level data (e.g., a task list) corresponding to the work activity. Herein, the database may be preconfigured to store one or more task lists for each NOC type that qualifies a work activity as a dynamic activity task 3702. For example, the database may store one or more predetermined task lists for a “field assessment” NOC. FIG. 38 illustrates one embodiment of a first “field assessment” NOC task list 3820 being directed to a medical call regarding a respiratory issue. FIG. 38 illustrates the two tasks that are to be completed in order to complete the work activity 3800 (“Tuberculosis” and “Asthma”). Additionally, a second layer of detail may be provided for each task. As illustrated, the task, “Asthma,” includes three actions that comprise the task. Although not shown, the task “Tuberculosis” may also a second level of detail. When the work activity is provided to the service provider(s) electronically (e.g., via the UW platform application for a mobile phone as discussed above), second level of detail for each task may be collapsible or expandable. It should be noted that the database may be located in the same location as the UW platform, stored remotely (e.g., on a server farm), and/or within cloud computing space.

Upon retrieving the association level data, the association level logic 3704 transforms the association level data into a specific format specified by the UW platform corresponding to a layout used to present the work activity to each service provider. For example, a layout may be preconfigured for each work activity depending on the NOC, wherein one or more NOC types have different layouts. Alternatively, the layout may be the same for each NOC type. The association levels logic 3704 may then generate a file containing instructions for generation of a GUI including visually perceptible elements for each task. The visually perceptible elements may include text and/or pictures associated with a task (e.g., pictorial description of the task accompanying text, or pictorial description of the second level of detail for one or more tasks).

At block 4004, the hopper logic 20 generates a first notification ramp for the work activity and notifies service providers of the work activity according to the notification ramp. As discussed above, a notification ramp is a schedule for placing service providers according to a particular order in which they are to be notified of the work activity. Upon notifying the service providers according to the notification ramp and providing the service provider(s) who accept the work activity with the file containing instructions for generating the GUI, the method 4000 ends.

As discussed above, input into the UW platform may come from, at least, input via a GUI from a user (e.g., a medical patient, staff at a company, etc.) or one or more sensors (e.g., MEMs sensors). The one or more sensors may be paired with a circuit such as an integrated circuit or an application-specific integrated circuit (ASIC). Herein, the one or more sensors may be part of an Internet of Things (IoT) system. In one embodiment, a signal from one sensor may trigger the generation of a work activity. In a second embodiment, two or more signals may need to be received (e.g., all within a predetermined time of each other) in order to trigger the generation of a work activity.

When an IoT system has been established, the one or more sensors may be preconfigured to transmit a signal to a communications interface of the UW platform instructing the UW platform to generate a work activity based on the signal. An IoT system may be construed as a plurality of sensors working in concert via a network, typically a wireless network. As discussed above, the signal transmitted to the UW platform from the one or more sensors may include information comprising, but not limited or restricted to, (i) the NOC, (ii) additional comments or information including a problem that needs to be addressed, (iii) the time the request was transmitted to the UW platform, (iv) patient information (if applicable), which may include one or more of, inter alia, birthday, sex, blood type, past medical procedures, current medical conditions and/or social security number, (v) the location where assistance may be needed (e.g., global positioning system (GPS) coordinates, or address), and/or (vi) contact information of a responsible party (e.g., a patient, a family member, an owner of equipment that may need to be repaired, or janitorial staff of a company).

The sensors may be any sensor configured to work within an IoT system and may include, for example, temperature sensors, health monitors (e.g., pace makers, heart rate monitors, etc.), car sensors, door locks, microphones, light sensors, or sensors placed within an object that allows the sensor to record data. Upon configuration within the IoT system, the sensor may transmit a signal instructing the UW platform to generate a work activity due to some triggering event sensed by the sensor. For example, as briefly discussed above, an IoT system may be established at a butchery with sensors configured to monitor the temperature of one or more freezers within the butchery. The sensors may take readings at predetermined time intervals, e.g., every second, every minute, every 10 minutes, etc. Logic within each sensor may be configured to analyze the readings from the sensor and trigger the transmission of the signal to the UW platform.

As one example, when one or more sensors recording the temperature of a freezer within a butchery determine the increase in temperature within a predetermined time span has exceeded a first threshold (e.g., the temperature has risen 5 degrees within one hour), one or more of the sensors send a signal to the UW platform (possibly via the UW IoT platform as discussed below). The signal, which instructs the UW platform to generate a work activity based on the temperature-rising event, includes information describing the event such as one or more of, inter alia, (i) the increase in temperature over the time span, (ii) the initial temperature, (iii) the temperature at the end of the time span, (iv) a unique identifier of the freezer, (v) the beginning time of the time span, and/or (vi) the end time of the time span.

Upon receipt of the signal, the UW platform generates a work activity and, in some embodiments, determines whether the work activity qualifies as a dynamic activity sequence 3701 or a dynamic activity task 3702. The generation of the work activity results in at least a portion of the information included in the signal received from the one or more sensors being placed in a standardized format (e.g., a work activity) that is then provided to one or more service providers.

In some embodiments, the UW platform may be connected to a plurality of IoT systems, wherein the IoT systems are unrelated. In such embodiments, the information included within the signals received from the unrelated IoT systems may differ in substance and format. The UW platform parses a signal from a first IoT system and generates a first work activity in a standardized format and parses a signal from a second IoT system generates a second work activity in the same standardized format as the first work activity. However, the UW platform may generate work activities that only include information associated with the corresponding received signal and the IoT system from which the signal was derived.

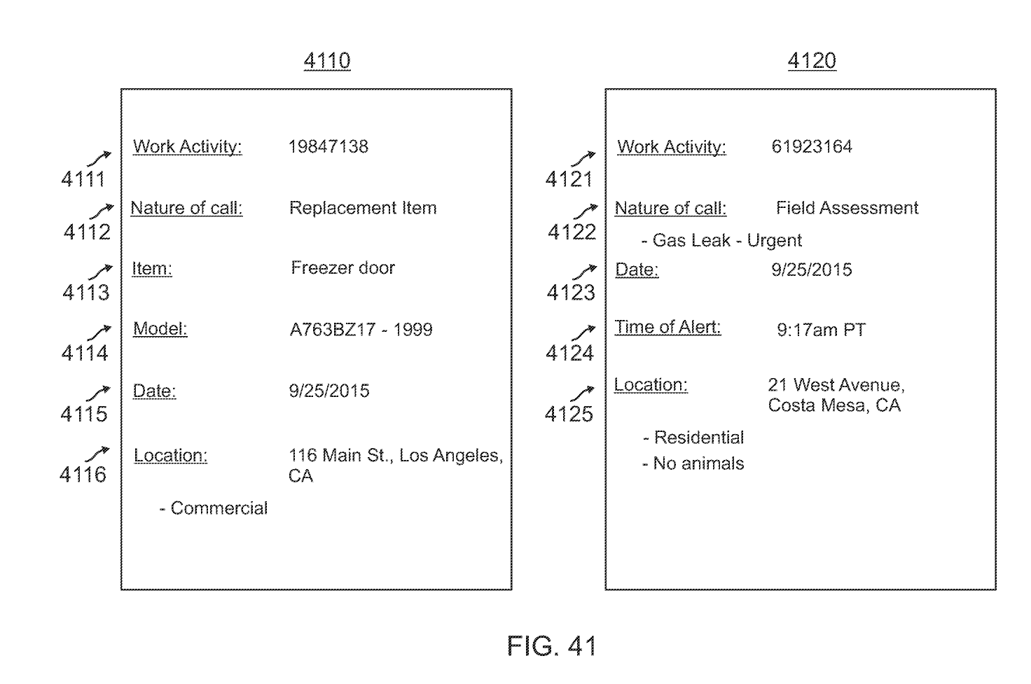

Referring to FIG. 41, an illustration of a first exemplary work activity and a second exemplary work activity is shown. The first work activity 4110 may have been generated as a result of a signal from a first IoT system, e.g., an IoT system associated with a freezer in a butchery, as mentioned above. The second work activity 4120 may have been generated as a result of a signal from a second IoT system, e.g., an IoT system associated with a security system at a residential home. The first and second IoT systems are completely unrelated and typically the information received by the UW platform from each IoT system will vary drastically. Such variance does not promote efficiency among the service providers. However, the UW platform receives the varying information and may generate a work activity for each signal in a standardized format. Therefore, service providers may easily understand the work activity, especially the nature of the call and any specific instructions and/or details, as each work activity is in a standardized format.

The work activity 4110 includes a plurality of rows including: (i) the work activity identifier 4111; (ii) the nature of call 4112; (iii) the item 4113; (iv) the model 4114; the date (e.g., that the request was made); and (v) the location at which the item is to be replaced. The work activity 4120, generated as a result of a signal from a home security system for example, has a “field assessment” NOC, directed to a gas leak that is labeled as “URGENT.” Herein, the work activity 4110 having a “replacement item” NOC includes information that varies greatly from the work activity 4120. However, a service provider can easily understand both work activity 4110 and work activity 4120 and efficiently complete the each if the service provider is qualified to do so.

The work activities illustrated in FIG. 41 highlight a few of the details that may be included in signals received from an IoT system and/or pulled from a database. For example, looking at the work activity 4110, the “replacement item” NOC may include details such as item type, model of the item, date the signal was received/transmitted, location where the replacement part is needed. Additionally, the location may include additional details such as whether the location is a residential home or a commercial business. The work activity 4120 having a “field assessment” NOC may include one or more details that differ from those included in the work activity 4110 and/or may exclude one or more details included in the work activity 4110. Herein, in one embodiment, one or more of the details included in either of the work activity 4110 or 4120 may be pulled from a database based on the signal corresponding to the work activity. For example, details about the location may be pulled from a database (e.g., whether the location is residential or commercial, and whether animals reside at the location).

Referring to FIG. 42, an exemplary illustration of a flow of a process of generating a condition-generated work activity is shown. The flow of FIG. 42 is comprised of a plurality of columns, wherein each column represents a component of the flow. Each column, or component, is further broken down into a plurality of secondary components that illustrate the flow in a higher level of granularity. In this embodiment, four columns are shown: (1) event producers 4210, (2) Unified Workforce IoT platform 4220, (3) Unified Workforce Platform 4230, and (4) Engagement 4240.

At a high level, the secondary components comprising the event producers 4210 generate and collect data, and transmit the data to the UW IoT platform 4220. The data may be either raw data, filtered data or a signal instructing the UW platform 4230 to generate a work activity. In one embodiment, the sensors 4212₁-4212ⱼ (wherein j≦1) may record data from one or more of the assets 4211₁-4211ᵢ (wherein i≦1) and transmit the data to the UW IoT platform 4220 at predetermined time intervals. In a second embodiment, the sensors 4212₁-4212ⱼ may filter the data such that the data is transmitted to the UW IoT platform 4220 when a change in data from a particular sensor of the sensors 4212₁-4212ⱼ exceeds a predetermined threshold within a predetermined time interval. In yet another embodiment, the sensors 4212₁-4212ⱼ may include logic to analyze the data such that when a change in data from one or more particular sensors of the sensors 4212₁-4212ⱼ exceeds a predetermined threshold within a predetermined time interval, one or more of the sensors 4212₁-4212ⱼ generates a signal instructing the UW workforce platform 4230 to generate a work activity. In such an embodiment, the UW IoT platform may record the signal in the storage 4223 and transmit the signal to the UW platform 4230.

The assets 4211₁-4211ᵢ may include any object with which a sensor 4212₁-4212ⱼ exceeds may be associated, wherein the sensor is connected to an IoT system. For example, a sensor may be placed within a lighting component, within a freezer (e.g., the sensor being a thermometer), a greenhouse (e.g., the sensor being a humidity sensor), a door (e.g., a door position sensor), etc. The sensors 4212₁-4212ⱼ may be any sensor that is connectable to an IoT system. Additionally, a signal may be generated from the Independent System Operator (ISO), for example, the California ISO (CAISO). In such an embodiment, one or more sensors would be connected to the computers of the ISO such that electrical usage data may be analyzed by the ISO, enabling the ISO to signal one or more UW platforms to generate a work activity order. Alternatively, the ISO may generate a signal directly to an assert 4211₁-4211ᵢ instructing the assert 4211₁-4211ᵢ to perform some action (e.g., shut off electrical use).

The UW IoT platform 4220 receives the data from the sensors 4212₁-4212ⱼ and aggregates and filters the data. For example, in one embodiment, raw data transmitted by the sensors 4212₁-4212ⱼ may need to be analyzed and filtered to determine whether a change exceeding a threshold of a particular sensor occurred prior to generating an instruction to generating a work activity. Additionally, a change exceeding a first predetermined threshold for a first sensor and a change exceeding a second predetermined threshold for a second sensor may be required within a predetermined amount of time prior to the UW IoT platform generating an instruction for the UW platform 4230 to generate a work activity. The UW IoT platform 4220 may also store the data provided by the sensors 4212₁-4212ⱼ (raw and/or filtered) and/or the signal provided to the UW platform 4230 instructing the UW platform 4230 to generate a work activity.

The device management 4221 may perform maintenance automatically on one or more of the sensors 4212₁-4212ⱼ by transmitting software updates to one or more of sensors 4212₁-4212ⱼ. Additionally, the device management 4221 may analyze the data provided by the sensors 4212₁-4212ⱼ to determine whether each of the sensors 4212₁-4212ⱼ are functioning properly (e.g., always recording data, recording meaningful data, etc.). When one or more of the sensors 4212₁-4212ⱼ are not functioning properly, the device management 4221 may transmit a signal to the UW platform 4230 so that the UW platform 4230 may generate a signal to either a UW administrator and/or a service provider 4241₁-4241ₘ may perform maintenance (e.g., repair or replace the sensor).

The signal to the UW platform 4230 (as discussed in detail above) is received and a work activity is generated. In one embodiment, the UW platform 4230 determines whether the work activity qualifies as a dynamic activity sequence and/or a dynamic activity task (at secondary component 4232). During generation of the work activity, and during determination of whether the work activity qualifies as and generation of a dynamic activity sequence and/or a dynamic activity task, and during generation of a dynamic activity sequence and/or a dynamic activity task the storage 4233 may be accessed for retrieval of information based on the signal received by the UW platform 4230. Upon generation of the work activity, the UW platform 4230 generates a notification ramp and subsequently transmits a notification to one or more of the service providers 4241₁-4241ₘ.

The engagement component 4240 includes one or more service providers 4241₁-4241ₘ that may accept or deny the work activity (e.g., a sequence may require two or more separate service providers based on the events comprising the work activity). Upon completion of the work activity and/or an individual event within a sequence of events, a completion notification may be provided to the UW platform 4230 and/or the UW IoT platform. The UW platform 4230 may then generate a new notification ramp based on the next event in the sequence of events, if applicable. Additionally, the completion notification may be provided to the service provider engagement secondary component 4234.

The engagement component 4240 may also include one or more secondary components that enable feedback and/or ranking of the service providers 4241₁-4241ₘ. For example, the engagement component 4240 may include a points secondary component 4242 and a website ranking secondary component 4243. The secondary components for feedback and/or ranking may enable feedback via social media (e.g., blog posts, online bulletin boards, online ratings) and/or ranking according to positive and/or negative feedback for a particular service provider 4241₁-4241ₘ.

All of the systems, platforms, methods, etc. disclosed and claimed herein may be made and executed without undue experimentation in light of the present disclosure. While the systems and methods of this invention have been described in terms of particular embodiments, it will be apparent to those skilled in the art that variations may be applied to the systems and methods and in the steps, or in the sequence of steps, of the methods described herein without departing from the concept, spirit, and scope of the invention, as defined by the appended claims.

Components of the apparatuses, systems, and methods described herein may be implemented in hardware, software, or a combination of both. Where components of the apparatuses, systems and/or methods are implemented in software, the software (e.g., software including the algorithms discussed above) may be stored in an executable format on one or more non-transitory machine-readable mediums. Further, the algorithms, features, and/or steps of the systems and/or methods described herein may be implemented in software as a set of data and/or instructions. The algorithms, features, and/or steps of the systems and/or methods described herein may be implemented by causing a processor to process data and/or instructions. A machine-readable medium includes any mechanism that provides (e.g., stores and/or transports) information in a form readable by a machine (e.g., a computer). For example, a machine-readable medium includes read only memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Hardware used to implement the invention may include integrated circuits, microprocessors, FPGAs, digital signal controllers, stream processors, and/or other components.

This document does not intend to distinguish between components that differ in name but not function. Terms and phrases used in this document, and variations thereof, unless otherwise expressly stated, should be construed as open-ended as opposed to limiting. For example, in the following discussion and in the claims, the terms “including,” “includes,” “comprising,” “have,” and “has” are used in an open-ended fashion, and thus should be interpreted to mean “including, but not limited to.” Also, the terms “example” or “exemplary” are used to provide exemplary instances of the item in discussion, not an exhaustive or limiting list thereof. The terms “a” or “an” should be read as meaning “at least one,” “one or more,” or the like. The word “or” is used in the inclusive sense (i.e., “and/or”) unless a specific use to the contrary is explicitly stated. The presence of broadening words and phrases such as “one or more,” “at least,” “but not limited to” or other like phrases in some instances shall not be read to mean that the narrower case is intended or required in instances where such broadening phrases might be absent. The use of the term “module” does not imply that the components or functionality described or claimed as part of the module are all configured in a common package. Indeed, any or all of the various components of a module, whether control logic or other components, might be combined in a single package or separately maintained and might further be distributed across multiple locations. Where this document refers to technologies that would be apparent or known to one of ordinary skill in the art, such technologies encompass those apparent or known to the skilled artisan now or at any time in the future.

The particular embodiments disclosed above are illustrative only as the invention may be modified and practiced in different but equivalent manners apparent to those skilled in the art having the benefit of the teachings herein. Furthermore, no limitations are intended to the details of construction or design herein shown other than as described in the claims below. It is, therefore, evident that the particular embodiments disclosed above may be altered or modified and all such variations are considered within the scope and spirit of the invention. Accordingly, the protection sought herein is as set forth in the claims below.

What is claimed is:

1. A non-transitory computer readable storage medium having stored thereon instructions, the instructions being executable by one or more processors to perform operations including:
receive information describing an issue requiring assistance by one or more service providers;
generate a work activity based on the received information, the work activity including a standard format populated with at least a portion of the received information;
generate a notification schedule, the notification schedule being an ordering of a subset of qualified service providers of the one or more service providers in which the subset of qualified service providers are to be notified of the work activity; and
notify one or more service providers of the subset of qualified service providers of the work activity, the one or more service providers of the subset of qualified service providers selected according to the notification schedule.

2. The computer readable storage medium of claim 1, wherein the received information is received from a web portal.

3. The computer readable storage medium of claim 1, wherein the work activity is populated with qualification requirements.

4. The computer readable storage medium of claim 1, wherein the portion of the received information used to populate the work activity includes: a unique identifier of the work activity, a nature of the issue, and a location associated with the issue.

5. The computer readable storage medium of claim 1, wherein the ordering of the subset of qualified service providers is based on a point total for each of the subset of qualified service providers.

6. The computer readable storage medium of claim 5, wherein the ordering of the subset of qualified service providers lists a first service provider of the subset of qualified service providers having a highest point total first.

7. The computer readable storage medium of claim 5, wherein the point total for each of the subset of qualified service providers is based on one or more of: feedback regarding work product of each of the subset of qualified service providers, a number of posts each of the subset of qualified service providers creates, or distance from a location associated with the issue.

8. The computer readable storage medium of claim 1, wherein the received information is received from one or more sensors within an Internet of Things system.

9. The computer readable storage medium of claim 8, wherein the received information is transmitted automatically by the one or more sensors in response to an occurrence of a predetermined event.

10. The computer readable storage medium of claim 1, having stored thereon further instructions that, when executed by the one or more processors, perform operations further comprising:
determine whether the work activity qualifies as an activity sequence, wherein the activity sequence is a sequence of events comprising a solution to the issue requiring assistance and is based on a nature of the issue of the work activity.

11. The computer readable storage medium of claim 10, having stored thereon further instructions that, when executed by the one or more processors, perform operations further comprising:
responsive to determining the work activity qualifies as an activity sequence, retrieve the sequence of events corresponding to the nature of the issue of the work activity.

12. The computer readable storage medium of claim 11, having stored thereon further instructions that, when executed by the one or more processors, perform operations further comprising:
notify a first service provider of the subset of qualified service providers of a first event of the work activity; and
notify a second service provider of the subset of qualified service providers of a second event of the work activity.

13. The computer readable storage medium of claim 12, having stored thereon further instructions that, when executed by the one or more processors, perform operations further comprising:
prior to notifying the second service provider of the second task of the work activity, generate a second notification schedule, the second notification schedule being an ordering of a second subset of qualified service providers of the one or more service providers in which the second subset of qualified service providers are to be notified of the second event of the work activity.

14. A method comprising:
receiving information describing an issue requiring assistance by one or more service providers;
generating a work activity based on the received information, the work activity including a standard format populated with at least a portion of the received information;
generating a notification schedule, the notification schedule being an ordering of a subset of qualified service providers of the one or more service providers in which the subset of qualified service providers are to be notified of the work activity; and
notifying one or more service providers of the subset of qualified service providers of the work activity, the one or more service providers of the subset of qualified service providers selected according to the notification schedule.

15. The method of claim 14, wherein generating the notification schedule includes analyzing points earned by each service provider of the subset of qualified service providers and establishing the ordering such that a first service provider of the subset of qualified service providers with more points than a second service provider of the subset of qualified service providers is scheduled to be notified about the work activity prior to the second service provider with fewer points.

16. The method of claim 14, wherein generating the notification schedule includes determining a point total of all points of the subset of qualified service providers, determining a percentage of individual points of each service provider of the subset of qualified service providers compared to the point total, and establishing the ordering such that a first service provider of the subset of qualified service providers with a higher percentage than a second service provider of the subset of qualified service providers is scheduled to be notified about the work activity prior to the second service provider with a lower percentage.

17. The method of claim 15, wherein determining the percentage of individual points of each service provider of the subset of qualified service providers compared to the point total includes applying client preference criteria to the individual points of each service provider of the subset of qualified service providers to increase or decrease the individual points prior to determining the percentage.

18. A non-transitory computer readable storage medium having stored thereon instructions, the instructions being executable by one or more processors to perform operations including:
receiving credentials of a service provider; and
responsive to receiving the credentials of the service provider, generating an interactive display including a plurality of tiles, each of the plurality of tiles associated with one of educational material, a newsfeed, customization options for experience of the service provider, or customization options for work opportunity desires of the service provider.

19. The computer readable storage medium of claim 18, wherein a size of each of the tiles is proportional to an amount the service provider selects each of the tiles.

20. The computer readable storage medium of claim 18, having stored thereon further instructions that, when executed by the one or more processors, perform operations further comprising:
responsive to receiving an input from the service provider, generating a second interactive display including an assessment test for verifying a skill level of the service provider in a selected service area,
wherein the input includes a self-assessment of the skill level of the service provider in the selected service area.
